(19) United States
(12) Patent Application Publication
(10) Pub. No.: US 2014/0336953 A1
(43) Pub. Date: Nov. 13, 2014

(54) METHOD TO QUANTIFY EMISSION RATES IN ATMOSPHERIC PLUMES

(71) Applicants: Matthew Ronald JOHNSON, Ottawa (CA); NATIONAL RESEARCH COUNCIL OF CANADA, Ottawa (CA)

(72) Inventors: Matthew Ronald JOHNSON, Ottawa (CA); Robin William DEVILLERS, Viroflay (FR); Kevin Austen THOMSON, Ottawa (CA)

(73) Assignees: NATIONAL RESEARCH COUNCIL OF CANADA, Ottawa (CA); Matthew Ronald JOHNSON, Ottawa (CA)

(21) Appl. No.: 13/893,228

(22) Filed: May 13, 2013

(51) Int. Cl. G01N 21/85; G06F 17/17

(52) U.S. Cl. CPC G01N 21/85; G06F 17/17; G01N 2021/8578
USPC 702/24

(57) ABSTRACT

A new method of making sky-LOSA measurements (Line-Of-Sight Attenuation measurements of sky-light) of soot mass flux in atmospheric plumes has been developed which enables accurate measurements in the presence of in-scattered light from the sky and sun.

### TECHNICAL FIELD

The present disclosure relates to a method of quantifying soot or black carbon emission rates in atmospheric plumes, such as those emitted by gas flares.

### BACKGROUND

Bibliographic information for any references referred to in this section can be found at the end of the detailed description.

Particulate matter (PM) emissions into the atmosphere are a well-recognized health concern and exposure to PM is linked directly to adverse human health effects and mortality (US EPA, 2010). PM in the form of soot generated from combustion of fossil-fuels contains mostly black carbon, which is widely recognized as a critical source of anthropogenic climate forcing (e.g. US EPA, 2012; IPCC, 2007). The net effects of atmospheric black carbon emissions from fossil-fuel soot and solid-biofuel soot are thought to be the second most important cause of global warming after CO₂ (Bond et al., 2013; Jacobson, 2010).

Global gas flaring has been specifically identified as a critical source of black carbon emissions for which uncertainties are high and measured data are lacking (Arctic Council, 2011; US EPA, 2012). Concern over flare emissions is directly related to the very large volumes of gas flared globally. Primarily using industry reported data aggregated by individual countries, the United States Energy Information Administration estimated that approximately 122 billion m³ of gas were flared or vented in 2010 (U.S. Energy Information Administration, 2012). Separate estimates derived from visible light satellite imagery suggest that for 2010, global flare volumes alone were on the order of 134 billion m³ (NOAA, 2012).

Efforts to accurately quantify, regulate, and mitigate particulate matter emissions from flaring have been hampered by a lack of in-situ measurement techniques. The current industry and regulatory standard (EPA test method 9) relies on human observers to estimate opacity of plumes from sources including gas flares. An alternative implementation of EPA test method 9 uses a camera in place of the human observer to estimate the opacity of the plume. However, opacity is primarily an aesthetic descriptor and none of these approaches permits quantitative measurement of emission rates. Furthermore, very limited emissions data are available for flares under controlled conditions and existing emission factor data used by many regulatory agencies to inventory flare generated particulate matter are of questionable applicability (McEwen and Johnson, 2012).

An early prototype version of the Sky-LOSA (Line of Sight Attenuation) diagnostic (Johnson et al., 2011; Johnson et al., 2010) attempted quantification of particulate emission from gas flare plumes. However, the prototype approach lacked a technical methodology to correctly account for scattered light from the sky-dome and further, it was unable to account for interference from sunlight impacting the plume. Thus, reported measurements were necessarily performed at dusk to avoid any potential effects of sun-light scattering. Broader application of sky-LOSA as a viable measurement method requires a more robust approach for dealing with these potential interferences.

### BRIEF DESCRIPTION OF THE DRAWINGS

FIG. 1 is a schematic of sky-LOSA setup defining relevant angles and coordinate directions for the camera, sky, and sun;

FIG. 2 is a schematic of a control volume along the optical axis used to define terms in developed equations governing a sky-LOSA measurement;

FIG. 3 is a flowchart of a method according to an exemplary embodiment of the present disclosure;

FIG. 4A is a sketch of a representative unprocessed instantaneous image of a flare plume recorded at a turbocompressor station in Poza Rica on Dec. 2, 2011;

FIG. 4B is a representation of the measured transmissivity, τₑₓₚ, corresponding to the sketch of FIG. 4A, superimposed calculated instantaneous velocity vectors for the plume;

FIG. 5 is a table of measurement conditions for various frame series acquired in field measurements;

FIGS. 6A and 6B show a time-resolved soot emission rate for a flare at a turbocompressor station in Poza Rica, Mexico as measured via sky-LOSA. Data shown were acquired on Dec. 2, 2011 at 12:05 pm;

FIG. 7 is a table showing uncertainty on the soot emission rate and contribution of various error sources;

FIG. 8 is a table showing input parameters used for the analysis of sky-LOSA data;

FIG. 9A is a graph showing the influence of various model assumptions involved in calculation of in-scattering on calculated mass emission rate of soot;

FIG. 9B is a graph showing the influence of various model assumptions involved in the calculation of in-scattering on the magnitude of sky-light in-scattering parameter; and

FIG. 10 is a schematic of the angles used for calculation of a total scattering cross-section.

### DETAILED DESCRIPTION

Bibliographic information for any references referred to in this detailed description can be found in section 8.

This disclosure details a new technique for quantitatively measuring soot emission rates in flare plumes under field conditions, which has potential to significantly improve understanding of flare generated particulate matter emissions. Known as sky-LOSA (where LOSA is an acronym for Line-Of-Sight Attenuation), this optical technique measures plume velocity and monochromatic transmissivity of sky-light through the plume, which can be related to mass emission rate of soot via Rayleigh-Debye-Gans theory for fractal agglomerates. The use of optical transmissivity data to ascertain soot concentrations is a well-established laboratory-based measurement technique (e.g. Greenberg and Ku, 1997; Snelling et al., 1999; Thomson et al., 2008) where conditions and optical interferences are readily controlled. However, for in-situ measurements of atmospheric plumes using sky-LOSA, data analysis is complicated by potential effects of secondary scattering by the plume of incoming light from the sky-dome and sun.

A method of making a sky-LOSA measurement has been derived that enables accurate measurement of soot mass flux within an atmospheric flare plume in the presence of in-scattered light from the sun and from the hemispheric sky-dome (i.e. light scattered by the plume toward the camera that originates from the sun and other parts of the sky-dome not directly imaged by the camera). Using a combination of supplemental measurements and models of sky light intensity distribution and soot-light interaction theory, a methodology to quantify and correct for the biases due to in-scattering of sun-light directly incident on the plume and in-scattering of sky-light from regions of the sky not directly imaged by the sensor has been developed. The method allows experimentally-measured transmissivity data to be directly related to an idealized transmissivity in the absence of in-scattering, where the latter can then be used to accurately quantify soot mass emission rates.

In addition to correcting for measurement biases, an aspect of the method allows for a procedure for quantifying measurement uncertainties and minimizing these uncertainties as a function of the measurement location and meteorological conditions. The method uniquely uses measured plume transmissivity or the logarithm of plume transmissivity as the data source for image correlation velocimetry measurements such that the determined velocity is intrinsically weighted by the local concentration along the line of sight of the detection system.

In addition to measurement of plumes from flares and stacks, the method can be used to measure a range of particulate matter plumes including those generated via open burning of biomass as well as from brick kilns or similar industrial processes. Further, the method could be used to remotely measure particulate matter plumes of ships or other similar transport equipment. A spectral version of sky-LOSA in which measurements are repeated at two or more wavelengths could be used to glean information on the types and form of particulate matter being emitted.

In any of these cases, the method can be combined with measurements of the fuel composition and flow rate to allow calculation of emission factors which are essential to both industry and regulators to allow accurate reporting of pollutant emissions, to enable proper management decisions and specification of operating practices, and to support design and implementation of mitigation technologies.

Implementations of the technology will now be described in detail. Each example is provided by way of explanation of the technology only, not as a limitation of the technology. It will be apparent to those skilled in the art that various modifications and variations can be made in the present technology. For instance, features described as part of one implementation of the technology can be used on another implementation to yield a still further implementation.

### 1 Considering In-Scattering of Sky Light and Sunlight

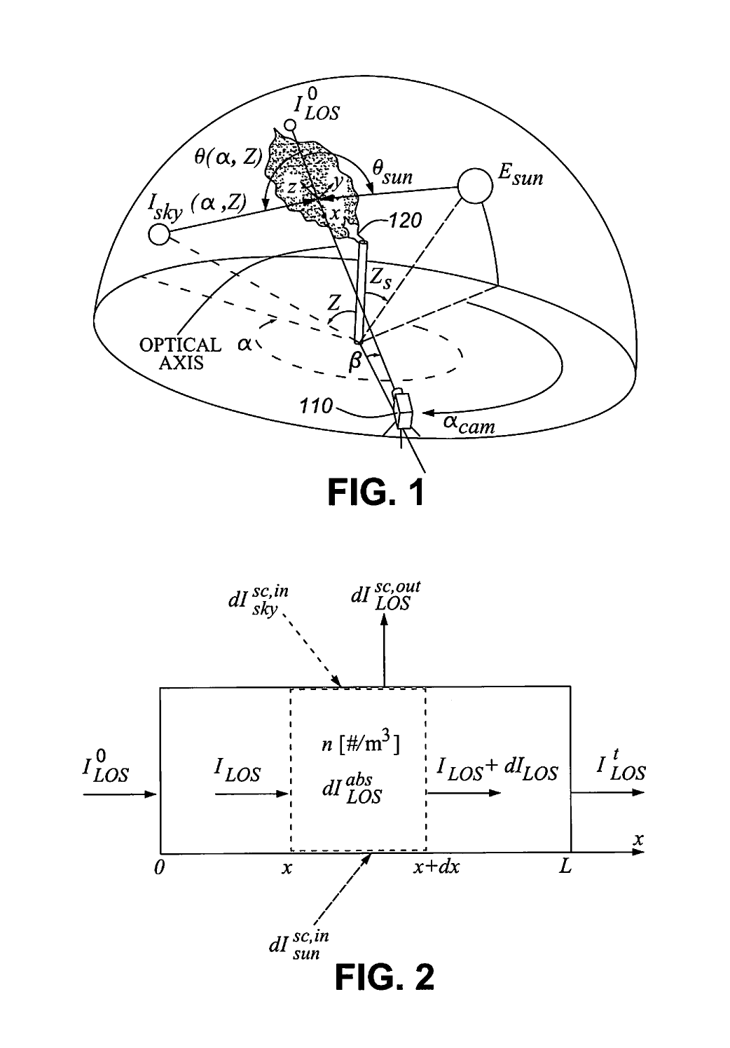

FIG. 1 defines relative optical detection system, sky, and sun angles for a generic sky-LOSA measurement of the plume 120. For the demonstration measurements described in Section 3, an sCMOS camera-based optical detection system was used although it is understood that other optical detector technologies could also be employed. Referring to FIG. 1, in order to make a sky-LOSA measurement an optical detection system 110 is set up so that it can take images of a plume 120. The optical axis for the sky-LOSA measurement (x-axis) is the optical axis of the detection system/camera, which transects the plume and has an elevation angle β above horizontal. The local radiance of the sky behind the plume (for a given solid angle along the optical axis) over the measured wavelength band is I_{LOS}⁰[W m⁻²ster⁻¹]. The radiance of sky-light as a function of zenith angle, Z (defined relative to a vertical axis centered at the measurement location), and azimuth angle, α (defined as positive in a clockwise direction relative to the position of the sun), is given by I_{sky}(α,Z) [W m⁻²ster⁻¹]. Finally, the plume irradiance by the sun over the measurement wavelength band is given by Eₛᵤₙ [W m⁻²]. Interpretation of acquired image data takes into account the relative importance of absorption and scattering of light along the measurement axis, in-scattering of hemispheric sky-light (i.e. light from other parts of the sky-dome scattered by the plume toward the camera), and in-scattering of sun-light.

By formulating a balance equation for light moving through the plume along the optical axis, it is possible to develop a generalized method for interpreting a sky-LOSA measurement that considers the effects of in-scattered light explicitly. FIG. 2 shows a schematic control volume along the optical axis of the sky-LOSA measurement as defined in FIG. 1. For a segment of the plume of infinitesimal length along the optical axis, dx:

dI_{LOS}(x)=dI_{LOS}^{abs}(x)−dI_{LOS}^{sc,out}(x)+dI_{sky}^{sc,in}(x)+dIₛᵤₙ^{sc,in}(x) (1)

where dI_{LOS}(x) is the change in radiance along the infinitesimal plume segment at the prescribed measurement wavelength band; dI_{LOS}^{abs}(x) is the local absorption of light by the plume; dI_{LOS}^{sc,out}(x) is the out-scattering of light by plume (i.e. scattering of the incoming light, I_{LOS}(x), that is initially propagating along the optical axis, away from the optical axis); dI_{sky}^{sc,in}(x) is the in-scattering by the local plume section of incoming hemispheric sky-light (i.e. scattering of hemispheric sky-light toward the camera along the optical axis); and dIₛᵤₙ^{sc,in}(x) is the in-scattering of sun-light. While eq. (1) directly accounts for secondary absorption and scattering of all light components that are directed along the optical axis, inherent in this equation is the assumption that prior to being scattered in the direction of the optical axis, any absorption of adjacent (off-axis) sky-light and sun-light as it enters the plume is negligible. As demonstrated in the analysis and measured results presented below, the ultimate influence of in-scattered light on the measurement is small relative to overall uncertainties, such that neglecting the second-order effect of off-axis light absorption prior to in-scattering is warranted. If desired in some future application, it could be possible to include small effects of absorption prior to scattering via numerical simulation based on the developed equations.

Referring to Section 6, which summarizes key equations for light absorption and scattering from small aggregated particles according to Rayleigh-Debye-Gans Fractal Aggregate (RDG-FA) theory, the terms on the right-hand side of eq. (1) can each be expanded in terms of soot optical properties as follows (all in [Wm⁻²ster⁻¹]):

$$\begin{matrix}d {I}_{LOS}^{abs} ( x ) = n ( x ) \overline{{σ}_{agg}^{abs}} {I}_{LOS} ( x ) d x & ( 2 ) \\ d {I}_{LOS}^{sc , out} ( x ) = n ( x ) \overline{{σ}_{agg}^{sca}} {I}_{LOS} ( x ) d x & ( 3 ) \\ d {I}_{sky}^{sc , i n} ( x ) = ( \begin{matrix}{\int }_{0}^{\frac{π}{2}} {\int }_{0}^{2 π} {I}_{sky} ( α , Z ) \overline{\frac{d {σ}_{agg}^{sc} ( θ ( α , Z ) )}{d {Ω}_{vv}}} \\ ( \frac{1 + {cos}^{2} θ ( α , Z )}{2} ) sin Z d α d Z\end{matrix} ) n ( x ) d x & ( 4 ) \\ \begin{matrix}d {I}_{sun}^{sc , i n} ( x ) = ( \begin{matrix}{\int }_{0}^{\frac{π}{2}} {\int }_{0}^{2 π} {I}_{sky} ( α , Z ) \overline{\frac{d {σ}_{agg}^{sc} ( θ ( α , Z ) )}{d {Ω}_{vv}}} \\ ( \frac{1 + {cos}^{2} θ ( α , Z )}{2} ) sin Z d α d Z\end{matrix} ) n ( x ) d x \\ = \overline{\frac{d {σ}_{agg}^{sc} ( θ ( α , Z ) )}{d Ω} {}_{vv}} ( \frac{1 + {cos}^{2} θ ( α , Z )}{2} ) \\ ( {\int }_{0}^{\frac{π}{2}} {\int }_{0}^{2 π} {I}_{sun} ( α , Z ) sin Z d α d Z ) n ( x ) d x \\ = \overline{\frac{d {σ}_{agg}^{sc} ( {θ}_{sun} )}{d Ω} {}_{vv}} \frac{1 + {cos}^{2} {θ}_{sun}}{2} {E}_{sun} n ( x ) d x\end{matrix} & ( 5 )\end{matrix}$$

In eq. (2) to (5), the following terms are defined:
n(x) is the number density of soot aggregates as a function position, x, along the optical axis [m⁻³];
σ̅_̅{̅a̅g̅g̅}̅^̅{̅a̅b̅s̅}̅ is the effective absorption cross-section of a soot aggregate, [m²].
σ̅_̅{̅a̅g̅g̅}̅^̅{̅s̅c̅}̅ is the effective total scattering cross-section of a soot aggregate [m²]; and

$$\overline{\frac{d {σ}_{agg}^{sc}}{d {Ω}_{vv}} vv }$$

is the effective differential scattering cross-section of a soot aggregate with respect to solid angle, Ω, and is a function of the scattering angle, θ; the subscript ‘vv’ indicates vertical polarization of both the incident and scattered light [m² ster⁻¹].

Equation (4) as presented is written for unpolarized sky-light, although as shown in Section 6, this is not a necessary assumption and its more general form given by eq. (39) could instead be used to account for a polarized component of sky-light. However, the slightly simpler version is used here since the added complexity is not required for general understanding of the energy balance, and the sample results presented below show that calculated emission rates are negligibly affected by the assumed sky-polarization state used to formulate eq. (4).

For clarity of notation, the following terms can be defined, which are independent of x:

$$A = \overline{{σ}_{agg}^{ext}} = \overline{{σ}_{agg}^{abs}} + \overline{{σ}_{agg}^{sc}} = \overline{{σ}_{agg}^{abs}} ( 1 + {ρ}_{sa} ) \\ \frac{B}{{I}_{LOS}^{0}} = {\int }_{0}^{\frac{π}{2}} {\int }_{0}^{2 π} \frac{{I}_{sky} ( α , Z )}{{I}_{LOS}^{0}} \overline{\frac{d {σ}_{agg}^{sc} ( θ ( α , Z ) )}{d Ω} {}_{vv}} ( \frac{1 + {cos}^{2} θ ( α , Z )}{2} ) sin Z d α d Z \\ \frac{C}{{I}_{LOS}^{0}} = \frac{{E}_{sun}}{{I}_{LOS}^{0}} \overline{\frac{d {σ}_{agg}^{sc} ( {θ}_{sun} )}{d Ω} {}_{vv}} \frac{1 + {cos}^{2} {θ}_{sun}}{2} \qquad ( 6 )$$

where σ̅_̅{̅a̅g̅g̅}̅^̅{̅e̅x̅t̅}̅ is the effective extinction cross-section of a soot aggregate and ρₛₐ= σ̅_̅{̅a̅g̅g̅}̅^̅{̅s̅c̅}̅/ σ̅_̅{̅a̅g̅g̅}̅^̅{̅a̅b̅s̅}̅ is the ratio of the effective total scattering and effective absorption cross-sections.

The terms in eq. (6) allow the governing equation for the change in light intensity along the optical axis to be written as:

dI_{LOS}(x)=AI_{LOS}(x)n(x)dx+Bn(x)dx+Cn(x)dx (7)

Equation (7) corresponds to a linear, first order, non-homogeneous, ordinary differential equation that can be solved via integration to yield:

$${I}_{LOS} ( x ) = \frac{B + C}{A} [ 1 - exp ( - A {\int }_{0}^{x} n ( x ) d x ) ] + {I}_{LOS}^{0} exp ( - A {\int }_{0}^{x} n ( x ) d x ) \qquad ( 8 )$$

During a sky-LOSA measurement, the camera records intensity information sufficient to quantify an experimentally measured plume transmissivity, τₑₓₚ=I_{LOS}(x)/I_{LOS}⁰, which from (8) is equivalent to:

$${τ}_{exp} = \frac{{I}_{LOS} ( x )}{{I}_{LOS}^{0}} = \frac{B + C}{A {I}_{LOS}^{0}} [ 1 - exp ( - A {\int }_{0}^{x} n ( x ) d x ) ] + exp ( - A {\int }_{0}^{x} n ( x ) d x ) \qquad ( 9 )$$

It is useful to define the idealized plume transmissivity, τ*, which would be observed in the limiting case where in-scattering of hemispheric skylight and direct sunlight by the plume were zero (i.e. both B and C are thus zero):

τ*=exp(−A∫₀^{x}n(x)dx)) (10)

As explained in Section 6.1, from RDG-FA theory, the average absorption cross-section of an aggregate is a function of the average number of primary particles per aggregate, N̅, the primary particle diameter, dₚ, the optical wavelength, λ, and the soot absorption index of refraction function, E(m)_{λ}:

$$\overline{{σ}_{agg}^{abs}} = \overline{N} \frac{{π}^{2} {d}_{p}^{3}}{λ} E ( {m}_{λ} ) \qquad ( 11 )$$

Eq. (11) can be rearranged to solve for the volume of an average aggregate and subsequently multiplied by the number density of aggregates to calculate the volume fraction of soot aggregates, fᵥ:

$${f}_{v} = \frac{\overline{{σ}_{agg}^{abs}} λ}{6 π E ( {m}_{λ} )} n ( x ) = \frac{\overline{{σ}_{agg}^{ext}} λ}{( 1 + {ρ}_{sa} ) 6 π E ( {m}_{λ} )} n ( x ) \qquad ( 12 )$$

Combining (12) and (10) reveals that the integrated soot volume fraction is directly relatable to the idealized plume transmissivity:

$${τ}^{*} = exp ( \frac{- 6 π ( 1 + {ρ}_{sa} ) {E ( m )}_{λ}}{λ} {\int }_{0}^{x} {f}_{v} d x ) \qquad ( 13 )$$

For a chord through the plume coincident with the optical axis of a sky-LOSA measurement, the local mass flow rate of soot is given by

d\dot{m}ₛₒₒₜ=ρₛₒₒₜu(y)∫ᵥdxdy (14)

where ρₛₒₒₜ is the soot density, the coordinate axis y is perpendicular to both the optical axis (x) and the general flow direction of the plume, and u(y) is the component of the characteristic local velocity of the plume chord that is perpendicular to y and x.

Invoking eq. (13) and integrating across the plume width in the y-direction allows the total mass flow rate of soot to be calculated as:

$${\dot{m}}_{soot} = \frac{{ρ}_{soot} λ}{6 π ( 1 + {ρ}_{sa} ) {E ( m )}_{λ}} \int u ( y ) ( - ln [ {τ}^{*} ( y ) ] ) d y \qquad ( 15 )$$

where τ* can be obtained from an experimental measurement of τₑₓₚ via a rearrangement of eq. (9) and (10):

$${τ}^{*} = ( {τ}_{exp} - \frac{B + C}{{I}_{LOS}^{0} A} ) {( 1 - \frac{B + C}{{I}_{LOS}^{0} A} )}^{- 1} \qquad ( 16 )$$

Eq. (15) is similar in form to the expressions previously derived (Johnson et al., 2011; Johnson et al., 2010), but the incorporation of an explicit expression relating τ* to τₑₓₚ allows the method to be precisely generalized to account for in-scattering of both direct sunlight and hemispheric skylight.

An implication of the above equations is that the sky-LOSA technique yields an optical measurement of aerosol light absorption. When applied to the plume of a gas flare, where brown carbon (such as, but not limited to, soil humics, humic-like substances, tarry materials, and bioaerosols., see Andreae and Gelencser, 2006) would be non-existent or negligible, the sky-LOSA technique can provide a direct measurement of soot carbon (as defined in Andreae and Gelencser (2006), which is equivalent to “light absorbing carbon” (LAC) as defined in Bond and Bergstrom (2006)). In the absence of emitted brown carbon, these terms are synonymous with black carbon as it is commonly used in the climate modelling community.

The methods described herein require the measurement of relative sun and sky intensity, sun position calculation, plume position measurement, and LOSA axis angle measurement. An optional clear sky picture can improve sky model selection and interpolation uncertainty estimation. There are various means of obtaining this information that would be apparent to one skilled in the art.

### 2 General Application

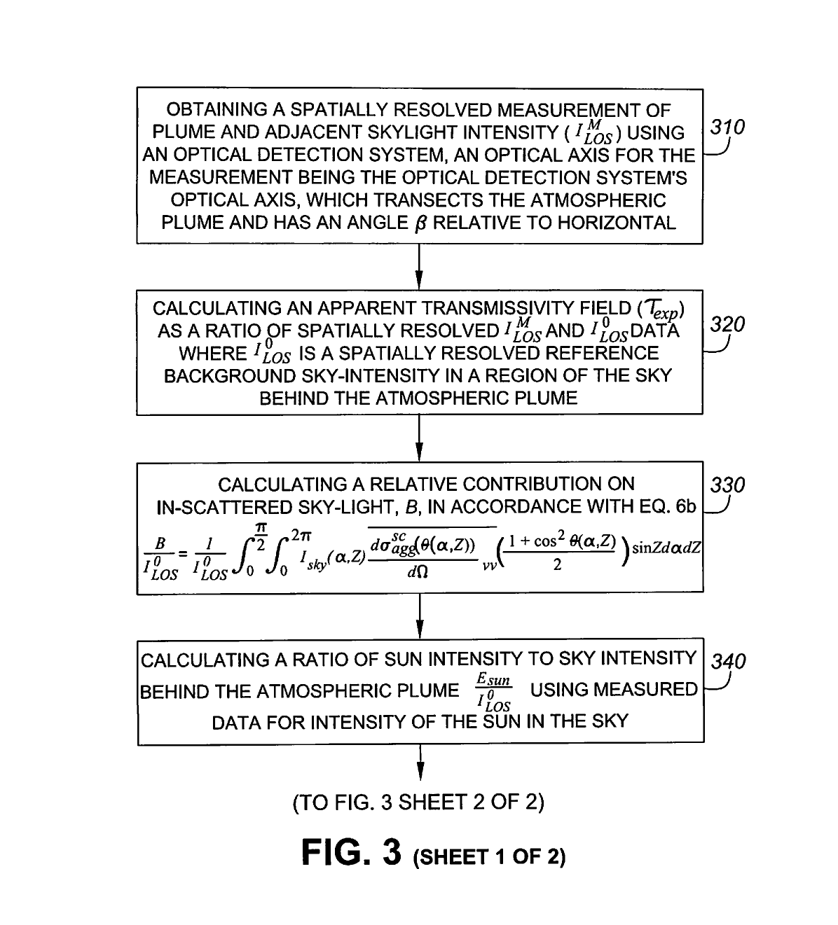

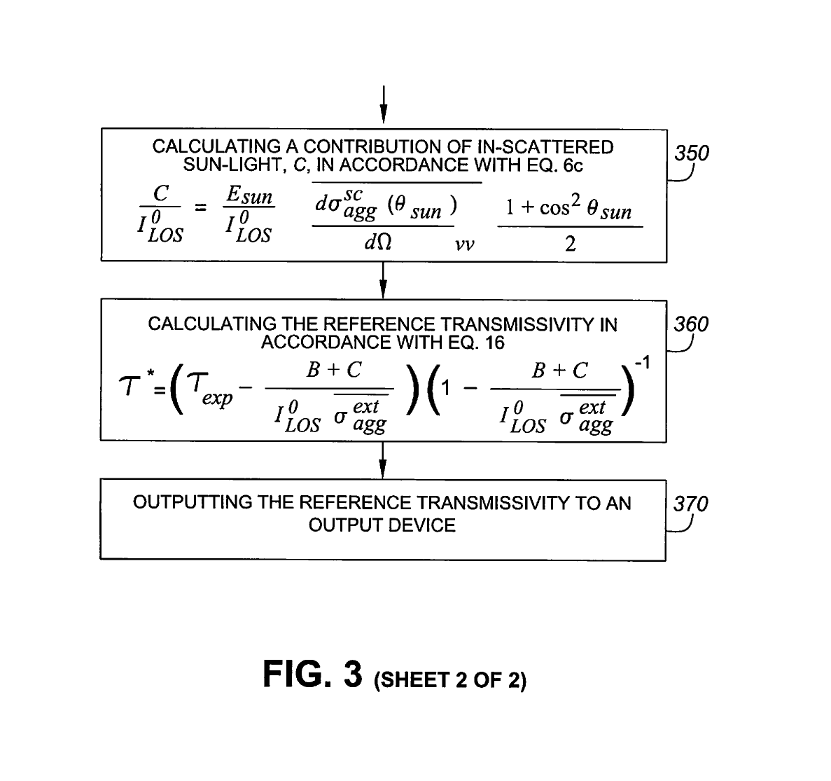

In one aspect, there is provided a method of determining a spatially resolved reference transmissivity field (τ*) of an atmospheric plume. An embodiment of such a method will now be described with reference to FIG. 3.

At action 310, a spatially resolved measurement of plume and adjacent skylight intensity (I_{LOS}^{M}) is obtained using an optical detection system, an optical axis for the measurement being the optical axis of the detection system, which transects the atmospheric plume and has an angle β relative to horizontal. In some embodiments, the optical detection system comprises one or more cameras.

At action 320 an apparent transmissivity field (τₑₓₚ) is calculated as a ratio of spatially resolved I_{LOS}^{M} and I_{LOS}⁰ data where I_{LOS}⁰ is a spatially resolved reference background sky-intensity in a region of the sky behind the atmospheric plume;

At action 330, a relative contribution of in-scattered sky-light, B is calculated in accordance with eq. 6b

$$\frac{B}{{I}_{LOS}^{0}} = \frac{1}{{I}_{LOS}^{0}} {\int }_{0}^{\frac{π}{2}} {\int }_{0}^{2 π} {I}_{sky} ( α , Z ) \frac{\overline{d {σ}_{agg}^{sc} ( θ ( α , Z ) ) }}{d {Ω}_{vv}} ( \frac{1 + {cos}^{2} θ ( α , Z )}{2} ) sin Z d α d Z \qquad ( 6 b )$$

where
I_{sky}(α,Z) is a radiance originating from a location in the sky specified by angles α and Z [W m⁻²ster⁻¹];
α is an azimuth angle between a first plane and a second plane, the first plane containing the sun and a measurement zenith axis and the second plane containing a position in the sky of interest and the measurement zenith axis, where the azimuth angle is defined to be positive in a clockwise direction relative to the first plane when looking down to the surface of the earth and the measurement zenith axis is defined as a vertical axis relative to the surface of the earth originating at a measurement location;
Z is a zenith angle between a line connecting a position in the sky of interest and the measurement zenith axis, the zenith angle being equal to zero when the position of the sky is directly above the measurement location;
θ(α, Z) is an angle between a line connecting the measurement location and the position in the sky of interest, defined by the angles α and Z, and a second line defined by the optical axis of the optical detection system, the angle θ being equal to zero when the position in the sky is intersected by the optical axis;

$$\frac{\overline{d {σ}_{agg}^{sc} ( θ ( α , Z ) )}}{d {Ω}_{vv}}$$

is the effective differential scattering cross-section of a soot aggregate with respect to solid angle, Ω, and is a function of the scattering angle, θ [m²ster⁻¹] and the subscript ‘vv’ indicates vertical polarization of both the incident and scattered light.

At action 340, a ratio of sun intensity to sky intensity behind the atmospheric plume

$$( \frac{{E}_{sun}}{{I}_{LOS}^{0}} )$$

is calculated using measured data for intensity of the sun in the sky.

At action 350, a contribution of in-scattered sun-light, C, is calculated in accordance with eq. 6c

$$\frac{C}{{I}_{LOS}^{0}} = \frac{{E}_{sun}}{{I}_{LOS}^{0}} \frac{\overline{d {σ}_{agg}^{sc} ( {θ}_{sun} )}}{d {Ω}_{vv}} \frac{1 + {cos}^{2} {θ}_{sun}}{2} \qquad ( 6 c )$$

where θₛᵤₙ is an angle between a line connecting the measurement location and the sun and a second line defined by the optical axis of the optical detection system, the angle θₛᵤₙ being equal to zero when the optical detection system's optical axis intersects the sun.

At action 360, the reference transmissivity is calculated in accordance with eq. 16

$${τ}^{*} = ( {τ}_{exp} - \frac{B + C}{{I}_{LOS}^{0} \overline{{σ}_{agg}^{ext}}} ) {( 1 - \frac{B + C}{{I}_{LOS}^{0} \overline{{σ}_{agg}^{ext}}} )}^{- 1} \qquad ( 16 )$$

where σ̅_̅{̅a̅g̅g̅}̅^̅{̅e̅x̅t̅}̅ is the measured or calculated extinction coefficient of the target constituents of the plume at a specified measurement wavelength band. In general, measurements occur over a range of wavelengths, even if that range is less than 1 nm. In this disclosure the range of wavelengths, no matter how small, is referred to as a wavelength band.

At action 370, the reference transmissivity is output to an output device. Non-limiting examples of the output device include a display screen, a printer, and a storage medium.

In some embodiments, sky-light polarization variation is considered when calculating a relative contribution of in-scattered sky-light, B, via the following modified form of eq. 6b

$$\frac{B}{{I}_{LOS}^{0}} = \frac{1}{{I}_{LOS}^{0}} ( {\int }_{0}^{\frac{π}{2}} {\int }_{0}^{2 π} [ {{I}_{sky} ( α , Z )}_{v} \frac{\overline{d {σ}_{agg}^{sca} ( θ ( α , Z ) )}}{d {Ω}_{vv}} + {{I}_{sky} ( α , Z )}_{h} \frac{\overline{d {σ}_{agg}^{sca} ( θ ( α , Z ) )}}{d {Ω}_{vv}} {cos}^{2} θ ( α , Z ) ] sin Z d α d Z ) \qquad ( 6 d )$$

where I_{sky}(α,Z)ᵥ is vertically polarized sky-light and I_{sky}(α,Z)ₕ is horizontally polarized sky-light for the position in the sky of interest, defined by the angles α and Z.

In some embodiments, C is assumed to be zero. Thus, only the effects of in-scattered sky-light are considered.

In some embodiments, B is assumed to be zero. Thus, only the effects of in-scattered sun-light are considered.

In some embodiments, the I_{LOS}⁰ data are determined via conditional averaging using a sequence of two or more image frames containing I_{LOS}^{M} data for which a conditional average is calculated to identify and average intensity data for instances in which a moving plume has migrated away from a target location of interest. This permits the optical detection system to sense unobstructed sky intensity data.

In some embodiments, the I_{LOS}⁰ data are determined via conditional averaging using a sequence of two or more image frames containing I_{LOS}^{M} data for which the conditional average is constructed using tests of statistical significance to develop objective statistical criteria for identifying and averaging intensity data for instances in which a moving plume has migrated away from a target location of interest. This permits the optical detection system to sense unobstructed sky intensity data.

In some embodiments, the conditional averaging is used in combination with interpolation procedures. In these cases, the conditional averaging enables a reduction in the extent of the required background sky-intensity data (I_{LOS}⁰) that is determined by interpolation techniques.

In some embodiments, the method further comprises determining a velocity field of the atmospheric plume by using time-resolved reference transmissivity field (τ*) image data as a basis for cross-correlation measurements to achieve intrinsically weighted velocity measurement data along a line of sight of a velocity detection system.

In some embodiments, a logarithm of the time-resolved reference transmissivity field data is used to achieve a different intrinsic weighting of velocity measurement data along the line of sight of the velocity detection system.

In some embodiments, apparent transmissivity field data (τₑₓₚ) are used to achieve a different intrinsic weighting of velocity measurement data along the line of sight of the velocity detection system.

In some embodiments, a logarithm of apparent transmissivity field data is used to achieve a different intrinsic weighting of velocity measurement data along the line of sight of the velocity detection system.

In some embodiments, the detection system comprises two or more detectors which view the plume along different optical axes and further comprises combining data through cross-correlation to obtain a 3-D measurement of the weighted velocity field in the atmospheric plume.

In some embodiments, the method further comprises relating the reference transmissivity to τ* and measured velocity field data to obtain mass emission rate (\dot{m}ₛₒₒₜ) data of targeted plume constituents in accordance with eq. (15)

$${\dot{m}}_{soot} = \frac{{ρ}_{soot} λ}{6 π ( 1 + {ρ}_{sa} ) {E ( m )}_{λ}} \int u ( y ) ( - ln [ {τ}^{*} ( y ) ] ) d y \qquad ( 15 )$$

where ρₛₒₒₜ is soot density, the coordinate axis y is perpendicular to both the optical axis (x) and the general flow direction of the plume, and u(y) is the component of the characteristic local velocity of the plume chord that is perpendicular to y and x.

In some embodiments, ρₛₐ is assumed to be zero.

In some embodiments, the detection system comprises two or more detectors and further comprises calculating velocity data using one or more of the two or more detectors and calculating transmissivity field data using one or more of the two or more detectors.

In some embodiments, the detection system comprises two or more detectors and further comprises calculating velocity data using one or more of the two or more detectors and calculating transmissivity field data using one or more of the two or more detectors, and further comprises closely positioning one or more sets of detectors such that the optical axes for transmissivity measurements and velocity measurements are equivalent so that misalignment errors due to the plume propagating out of the plane of the detector image data are intrinsically mitigated when transmissivity measurement data and velocity measurement data are integrated together in accordance with eq. (15).

In some embodiments, the same optical detection system is used for transmissivity measurements and velocity measurements.

In some embodiments, the method further comprises using measurements at two or more wavelength bands in the calculations and obtaining information about wavelength dependent scattering and absorption cross-sections of plume constituents.

In some embodiments, data from measurements at two or more wavelengths or wavelength bands are averaged to reduce measurement uncertainties.

In some embodiments, the described procedures and equations are used to enable quantification of measurement uncertainties.

In some embodiments, the sky-light intensity distribution I_{sky}(α, Z) is obtained by one or more sky-light intensity distribution models.

In some embodiments, the sky-light intensity distribution I_{sky}(α,Z) is obtained by direct measurement.

In some embodiments, the optical detection system comprises a camera.

In another aspect, there is provided a computer readable medium having computer readable instructions stored thereon, the instructions for implementing any of the methods described herein.

In another aspect, there is provided a method of determining a spatially resolved reference transmissivity field (τ*) of an atmospheric plume, the method comprising: obtaining a spatially resolved measurement of plume and adjacent skylight intensity (I_{LOS}^{M}) using an optical detection system, the optical axis for the measurement being the optical axis of the detection system, which transects the atmospheric plume and has an angle β relative to horizontal; calculating an apparent transmissivity field (τₑₓₚ) as a ratio of spatially resolved I_{LOS}^{M} and I_{LOS}⁰ data where I_{LOS}⁰ is a spatially resolved reference background sky-intensity in a region of the sky behind the atmospheric plume; calculating a relative contribution of in-scattered sky-light, B having regard to: a radiance originating from a location in the sky; an orientation of the sun with respect to a measurement location and the region of sky; and an effective differential scattering cross-section of a soot aggregate with respect to solid angle, Ω; calculating of a ratio of sun intensity to sky intensity behind the atmospheric plume

$$( \frac{{E}_{sun}}{{I}_{LOS}^{0}} )$$

using measured data for intensity of the sun in the sky; calculating a contribution of in-scattered sun-light, C, having regard to an angle between a line connecting the measurement location and the sun and a second line defined by the optical axis of the optical detection system; calculating the reference transmissivity having regard to a measured or calculated extinction coefficient of the target constituents of the plume at a specified measurement wavelength band; and outputting the reference transmissivity to an output device.

### 3 Methodology for Field Measurements

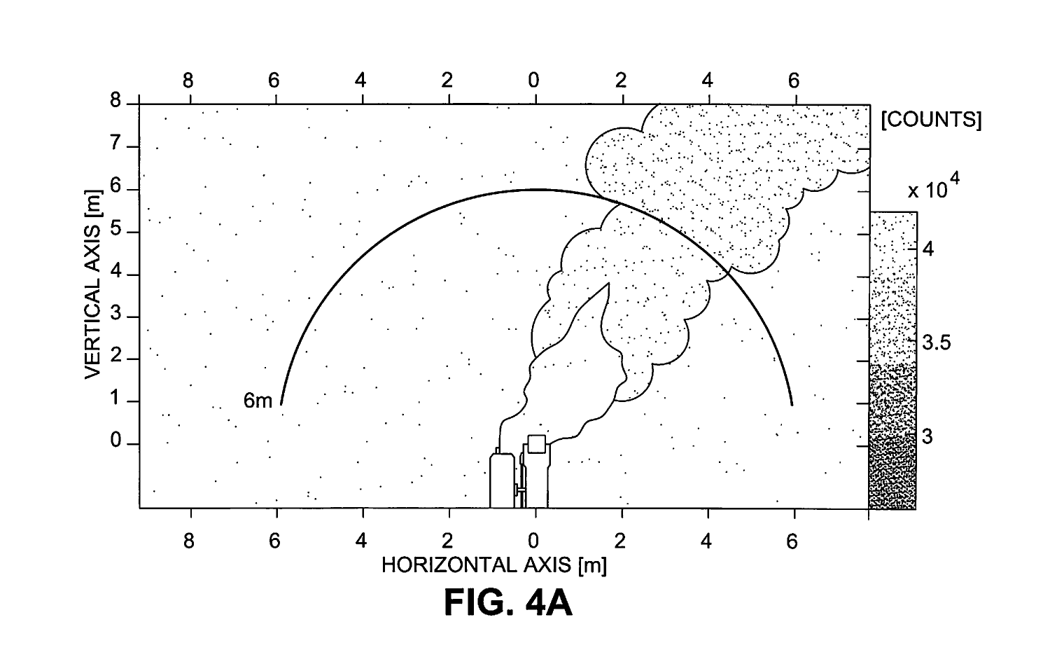

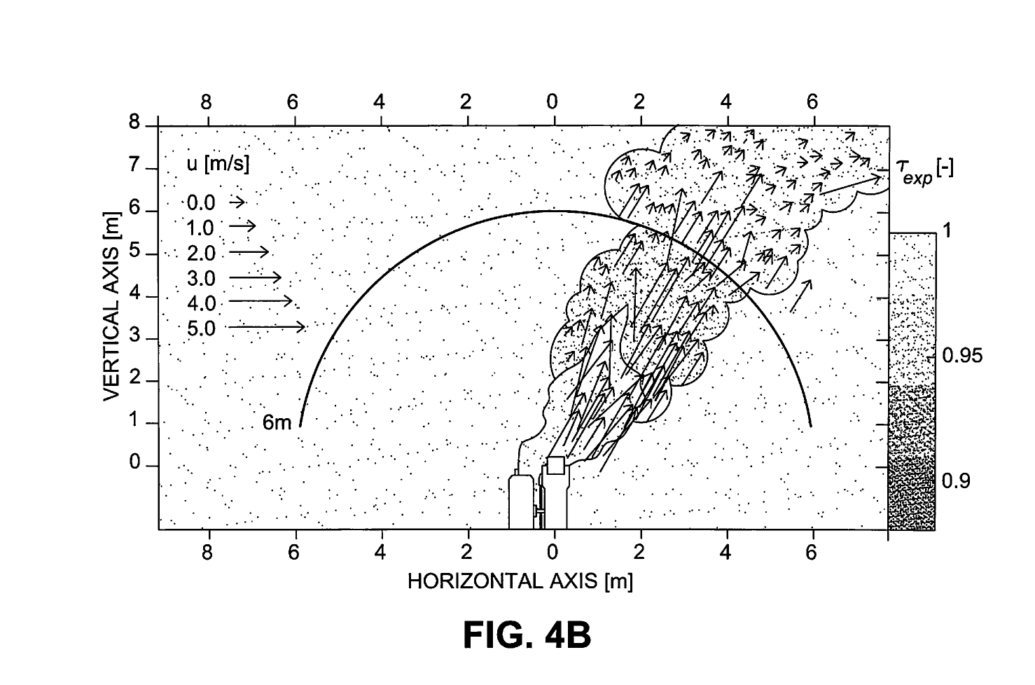

To test the above-described method, sky-LOSA images of an operating flare were acquired at a turbocompressor station near Poza Rica (20.4924° N, 97.4053° W) in the state of Vera Cruz, Mexico. A sketch of the flare is shown in FIG. 4A. To the naked eye, the soot emission from the flare was barely apparent as occasional faint wisps. FIG. 4B shows a representation of an image of the calculated transmissivity, τₑₓₚ, corresponding to the image of FIG. 4A, with superimposed calculated instantaneous velocity vectors for the plume.

Sky-LOSA images in the field experiments conducted were acquired with a sCMOS camera (pco.edge) with 27000:1 dynamic range and an effective 16-bit Analog to Digital (A/D) conversion resolution. Frame rates of up to 100 frames per second (fps) were achievable at a spatial resolution of 1600×1080 pixels, and 50 fps at 2560×2160 pixels. A single set of high-frame rate, high intensity resolution images could then be used for both transmissivity and velocity measurement, which is an improvement over the proof-of-concept system used in (Johnson et al., 2011). Specifically, the current apparatus enabled quantification of the instantaneous soot emission flux using time-resolved velocity and transmissivity fields, whereas the previous system was limited to emission rate data derived from separately acquired ensemble-averaged transmissivity and velocity data.

The camera was controlled by a ruggedized computer; both were powered by an inverter connected to the battery of a nearby vehicle. Because of the high data throughput from the camera, it was necessary to acquire images directly to the computer's 32 Gb RAM in intermittent bursts lasting up to 90 s (depending on the selected spatial resolution and frame rate). Data were then written to the harddrive (requiring several minutes) before the next burst could be acquired.

The sCMOS camera was coupled with a 50-mm, f/1.2 Nikon lens (AF Nikkor) and a narrow band filter centered at 531 nm (40 nm bandwidth at >95% transmissivity within the bandwidth). During measurements to evaluate the sun irradiance, Eₛᵤₙ, (as specified in eq. (5) or more specifically the ratio of the sun irradiance to reference sky radiance in the region of the plume, Eₛᵤₙ/I_{LOS}⁰ as is required for the evaluation of the idealized plume transmissivity, τ* via eq. (16)), calibrated neutral density (ND) filters were also mounted on the camera lens.

A laser range finder (TruPulse 360° R) mounted adjacent to the camera on a common tripod provided accurate distance from the camera to the stack tip. Combined with knowledge of the focal length of the camera lens, this enabled spatial calibration of the images remotely without the need to directly measure the stack diameter or other physical object in the plane of the plume. Specifically, the spatial calibration factor, F, in m/pixel can be calculated as

$$F = {L}_{pixel} \frac{{d}_{object}}{{d}_{image}} ,$$

where Lₚᵢₓₑₗ is the dimension of a pixel in the detector (6.5 μm in the present case), d_{object} is the distance from the camera lens to the plume, and d_{image} is the distance from the lens to the image plane of the detector (which is equal to the focal length of the camera lens, 50 mm in this case, when the lens is focused at infinity). The laser range finder has a rated accuracy between ±0.3 m and ±1.0 m, and camera to stack tip distances were measured with a repeatability of ±1 m in the field, leading to a spatial calibration uncertainty of ±2%. The range finder also provided the camera azimuth α_{cam} and inclination β. The coordinate locations of the measurement site were determined via GPS which combined with the time of day, allowed determination of the exact sun azimuth and zenith angle (Z_{S}), as shown in FIG. 1.

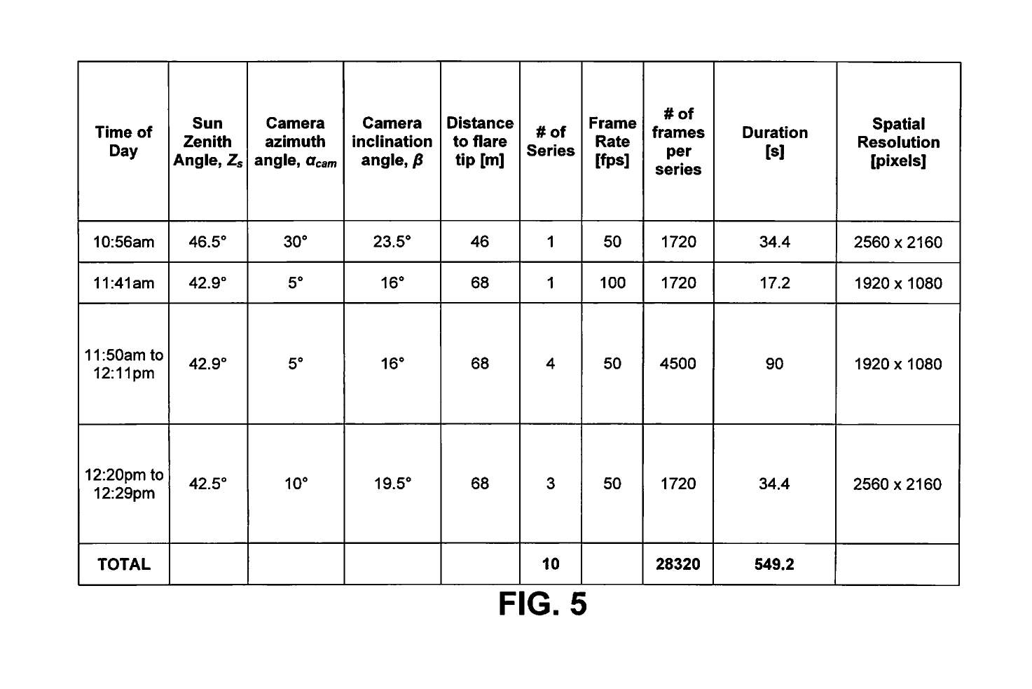

For the demonstration measurements described here, nine series of image frames were acquired from 10:56 am to 12:29 pm on Dec. 2, 2011 at frame rates of 50 fps or 100 fps (as detailed in Table 1 in FIG. 5). The acquisition duration of each series ranged from 17.2 s to 90 s depending of the frame rate and resolution. 26600 individual frames were acquired, equivalent to 513 s of continuous acquisition spread over approximately 90 minutes. A common exposure gate of 1 ms was set for all acquisitions. The camera azimuth angle, α_{cam}, defined in FIG. 1, varied from 5° to 30° with the repositioning of the camera and the movement of the sun in the sky; over this range of angles, the optical axis was essentially directed away from the sun (i.e. sun behind the camera).

To quantify and correct for the influence of direct irradiation of the plume by the sun, it is necessary to measure the ratio of the irradiance intensity of the sun to the radiant intensity sky light behind the plume,

$$\frac{{E}_{sun}}{{I}_{LOS}^{0}} ,$$

which appears in equation 6c, shown above. The relative intensity of the sky radiance, I_{LOS}⁰, can be determined from the camera pixel intensity reading, C_{sky} (measured in counts), which relates to the radiant intensity of the sky, I_{LOS}⁰, as:

$$\begin{matrix}{C}_{sky} = Δ {t}_{sky} {A}_{sky}^{ap} {τ}_{cam} {\int }_{{Ω}_{pixel}} {I}_{LOS}^{0} d Ω \\ = Δ {t}_{sky} {A}_{sky}^{ap} {τ}_{cam} {I}_{LOS}^{0} {Ω}_{pixel} \\ = Δ {t}_{sky} {A}_{sky}^{ap} {τ}_{cam} {{I}_{LOS}^{0} ( \frac{{L}_{pixel}}{f} )}^{2}\end{matrix} \qquad ( 17 )$$

where Δt_{sky} is the camera exposure time during a sky image acquisition, A_{sky}^{ap} is the aperture area of the camera lens, Ωₚᵢₓₑₗ is the solid angle of sky viewed by a pixel, and τ_{cam} is a scaling constant which accounts for the efficiency of the camera to record light (which is inclusive of the transmissivity of the narrow band filter on the lens and the quantum efficiency of the detector). As shown below, this scaling constant is common to both the sky and sun intensity readings and thus cancels out in a ratio of measurements. It is noted that integration of I_{LOS}⁰ over Ωₚᵢₓₑₗ is simply equal to the product I_{LOS}⁰Ωₚᵢₓₑₗ since variation of sky intensity over this solid angle will be small. The solid angle of sky viewed by a pixel is equal to (Lₚᵢₓₑₗ/f)² for a lens focussed at infinity, where f is the focal length of the lens.

During sun measurements, ND filters with known optical densities are mounted on the camera lens to enable direct imaging of the sun on the camera detector. For the demonstration measurements discussed in this application, three ND filters were used with optical densities of 3.0, 1.3, and 1.0. τ_{ND} is the net transmissivity of the neutral density filters. The intensity, in counts, of a camera pixel illuminated by the sun is:

Cₛᵤₙ=ΔtₛᵤₙAₛᵤₙ^{ap}τ_{cam}τ_{ND}∫_{Ω}_{ₚᵢₓₑₗ}IₛᵤₙdΩ (18)

Summing the intensity of all pixels illuminated by the sun is equivalent to integrating the intensity originating from the entire solid angle of the sun:

$$\begin{matrix}Σ {C}_{sun} = Δ {t}_{sun} {A}_{sun}^{ap} {τ}_{cam} {τ}_{ND} {\int }_{{Ω}_{sun}} {I}_{sun} d Ω \\ = Δ {t}_{sun} {A}_{sun}^{ap} {τ}_{cam} {τ}_{ND} {E}_{sun} .\end{matrix} \qquad ( 19 )$$

For the demonstration case, a measurement of sun irradiance Eₛᵤₙ, was conducted at 12:38 pm. 1720 frames of the sun and surrounding sky region were acquired at 50 fps with a spatial resolution of 2560×2160 pixels.

The ratio

$$\frac{{E}_{sun}}{{I}_{LOS}^{0}}$$

can be determined from eq. (20):

$$\frac{{E}_{sun}}{{I}_{LOS}^{0}} = \frac{Σ {C}_{sun}}{{τ}_{ND} {C}_{sky}} \frac{Δ {t}_{sky}}{Δ {t}_{sun}} \frac{{A}_{sky}^{ap}}{{A}_{sun}^{ap}} {( \frac{{L}_{pixel}}{{f}_{sky}} )}^{2}$$

For the demonstration case, where the same camera, lens, and exposure times were used for the sky and sun measurements, the ratios of aperture areas and exposure times cancel. More generally, it is to be understood that other cameras or detectors, optical filters, and/or range finders could be used to implement the methods described herein. Depending on factors such as the speed of the plume motion, the intensity of the sky-light, and the optical thickness of the plume to be measured, the sky-LOSA methodology would enable quantitative measurements using a range of equipment combinations. So long as maximum frame rates were sufficient to track the motion of the plume, detector spatial resolution and accuracy were sufficient to achieve the desired spatial resolution of the plume measurements, and the intensity resolution and accuracy of the detector were sufficient to quantify the optical thickness of the plume to the desired uncertainty level, then many different types of detector systems could be used. This could include but are not limited to other sCMOS detectors, Charge Coupled Device (CCD) detectors (which offer different specifications and frame capture rates), or standard CMOS detectors.

In the present example, distance from the camera lens to the plume was measured using a laser range finder. This distance could also be determined by a combination of global positioning system (GPS) measurements to determine the camera location and aerial photographs of the flare where latitude and longitude are indicated. Equally, distance to the plume is not required if an object of known size (e.g., the diameter of a flare stack) is captured in the plume image.

There are a myriad of camera lenses and optical filters which could be appropriate for SkyLOSA measurements. Depending on the relative positions of the camera and plume to be measured and the plume size, a range of lens focal lengths could be employed to best capture plume and sky image data for analysis. Similarly, while measurements in the demonstration case were performed using a 531 nm filter with a 40 nm bandwidth, the methodology could be usefully applied at other wavelengths.

### 4 Data Processing and Analysis

### 4.1 Measurement of τₑₓₚ and Plume Velocity

The experimentally measured transmissivity, τₑₓₚ, is the ratio of the measured plume radiance to a reference unattenuated sky radiance, obtained via interpolation through the region of the plume using adjacent unattenuated sky-light radiance data available in the acquired images. In the demonstration measurements, the sCMOS camera enabled acquisition of up to 4500 frames over time intervals of 90 s or less, during which the measured sky-light radiance was found to be effectively constant. This allowed the use of a conditional averaging approach to background sky radiance measurement that exploited the turbulent motion of the plume to reduce the reliance on interpolation and improve overall uncertainties.

In this approach, a clear-sky reference frame (i.e. where the sky is unattenuated by the plume) was iteratively determined from analysis of each complete plume frame series. To initiate the process, a single frame image was manually processed to exclude the visible plume and interpolate reference unattenuated-sky pixel intensities in this region using the LOESS interpolation algorithm (Cleveland and Devlin, 1988) as described previously (Johnson et al., 2011; Johnson et al., 2010). Next, each frame in the series was compared to the initial reference image on a pixel by pixel basis, and a new conditionally averaged reference sky-image was constructed that excluded pixels in any frame where the intensities were less than 99.5% of the corresponding intensity in the initial reference image. In this conditionally averaged image, pixels for which data from a majority of the frames had been excluded (i.e. where the plume was generally present), were subsequently replaced with updated reference intensities calculated by interpolation of the conditionally averaged image. This produced an updated clear-sky reference frame for the next iteration. This iterative procedure took advantage of the turbulent motion of the plume in the sky, which periodically revealed useful unattentuated sky intensity data within the region traversed by plume. As such, the area of the sky-region that needed to be evaluated by interpolation in the final iteration was reduced relative to the area that would need to be interpolated on any individual frame. In the present case, whereas interpolation widths of 250 pixels would typically be required for frame-by-frame interpolation analysis, reduced interpolation widths of 100-pixels were typically required using the conditional averaging procedure. Based on analysis of test interpolations in separately acquired clear-sky images, the current procedure more than halved the uncertainty contribution of the interpolation to the measured soot emission rate from ±4.7% to ±1.9%. The current procedure also significantly speeds up processing relative to a procedure based on frame-by-frame interpolation for the 26000+ frames considered.

Instantaneous plume velocities were calculated via Image Correlation Velocimetry (ICV) using the DaVis 7.2 software package (LaVision Inc.). Calculations were performed on the measured transmissivity images (τₑₓₚ) which simplified the need for contrast-optimization and sped up the processing. An example representation of a resultant instantaneous velocity frame is shown in FIG. 4B.

A very beneficial result of obtaining velocity and light attenuation data from measurements along a common optical axis, is that it is not necessary that the plane of the camera images be precisely aligned with the propagation of the plume. As the measurement axis deviates from being perpendicular to the direction of plume propagation by some angle φ, the measured velocity component in the plane of the camera image is reduced by a factor of cos(φ) while the length of the optical axis within the plume and hence the optical thickness simultaneously increases by a factor of 1/cos(φ). Stated another way, the camera records attenuation data on measurement chords perpendicular to its internal CCD array. Measured velocity components are necessarily parallel to the plane of this array, such that the combination of these data allows the calculation of a flux through a control surface of optical measurement chords that can be independent of the orientation of the plume. Thus, misalignment effects are inherently self-correcting in eq. (15).

### 4.2 Evaluation of Soot Morphological and Optical Property Data

Calculation of \dot{m}ₛₒₒₜ via eq. (15) and τ* via eq. (16) requires knowledge of soot morphology and optical properties. Measured values of these data are available in the academic literature and in the present case were obtained from a comprehensive survey of previous studies containing data relevant to post-flame soot (Dobbins et al., 1994; Köylü and Faeth, 1996; KayIli and Faeth, 1992; Köylü et al., 1995; Wu et al., 1997; Krishnan et al., 2000; Schnaiter et al., 2003; Yon et al., 2011; Cai et al., 1993; Cai et al., 1995; Bond et al., 2006; Coderre et al., 2011; Chang and Charalampopoulos, 1990; Tian et al., 2006; Di Stasio, 2000; McEwen and Johnson, 2012; Snelling et al., 2011; Iyer et al., 2007; Yang and Koylu, 2005; Ouf et al., 2008; Sorensen et al., 1992; De luliis et al., 2011; Choi et al., 1994; Choi et al., 1995; Jensen et al., 2007; Medalia and Richards, 1972; Mullins and Williams, 1987; Snelling et al., 2004). These studies employed a range of measurement methods relevant to the specific soot properties being investigated, and thus no one study captured all properties. Fuels considered include methane, propane, ethane, acetylene, ethylene, propylene, butadiene, cyclohexane, toluene, benzene, n-heptane, iso-propanol, JP8, and diesel. This broad range of gaseous and liquid fuels conservatively spans the anticipated narrower range of hydrocarbon-based fuels typical of upstream oil and gas flares. For other applications of sky-LOSA (e.g. biomass emission plume measurements), these soot properties should ideally be verified and/or adjusted as necessary using data specifically relevant to the combustion system under consideration.

Since these input data are not precisely known, their potential variation according to the specified probability distributions was considered in the analysis. This was accomplished via Monte-Carlo simulations in which 60,000 values of the inputs were randomly drawn in repeated calculations of all parameters contributing to \dot{m}ₛₒₒₜ allowing the overall uncertainty to be accurately assessed and the influence of individual parameters to be analyzed.

### 4.3 Determination of Optical Scattering Parameters B and C

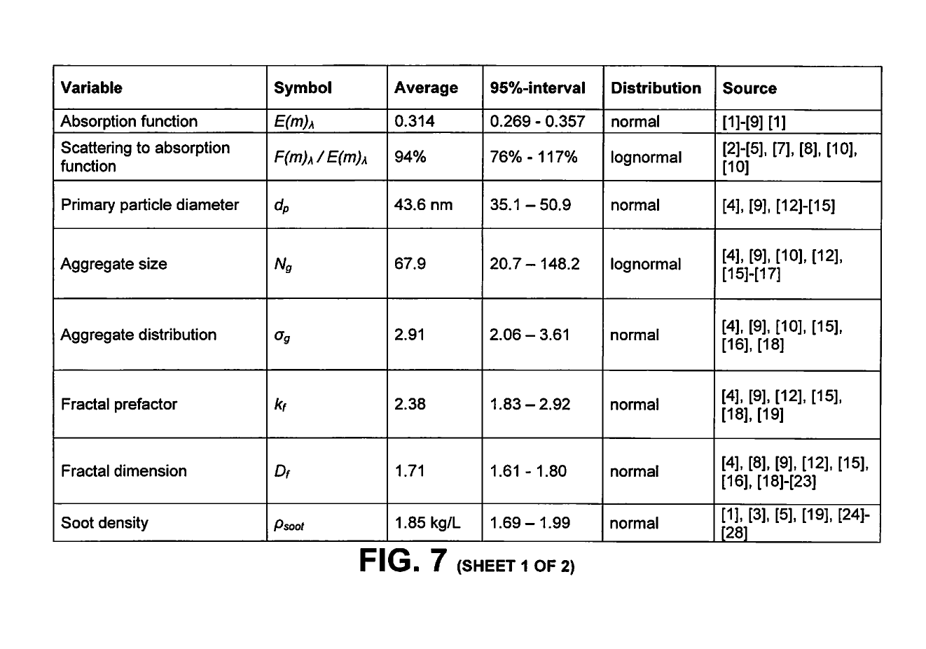

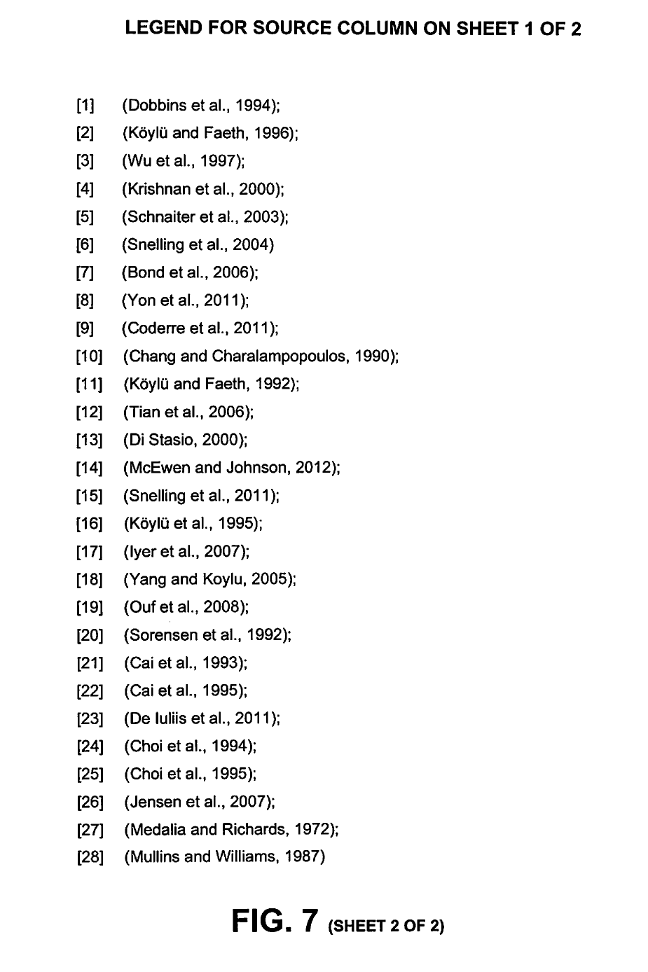

To calculate τ* from τₑₓₚ, parameters A,B/I_{LOS}⁰ and C/I_{LOS}⁰ must be evaluated (eq. (16)). Parameter A was calculated following the equations presented in Section 5 using relevant input data from Table 2 (FIG. 7). Parameter C/I_{LOS}⁰ includes the ratio of the irradiance of sun-light and sky-light,

$$\frac{{E}_{sun}}{{I}_{LOS}^{0}} ,$$

which was measured with the sCMOS camera as described in Section 3. Evaluation of parameter B/I_{LOS}⁰ requires knowledge of the spatial distribution of sky-light over the sky dome, I_{sky}. For the demonstration case, the standard sky distribution model of the CIE (CIE, 2003) was used for this purpose. Five different clear-sky formulas are available in the CIE model, which match various turbidity conditions. The five distributions were compared to the sky variations visible in the acquired images and the closest matching model (CIE Model VI.5) was used. As demonstrated in the results, the precise specification of the sky-model was not critical for accurate calculation of soot emission rates. In other implementations of sky-LOSA, direct measurements of sky-light intensity distribution could also be used rather than models. Calculations of parameters A, B and C were repeated for various soot morphology and optical property data as part of the Monte Carlo simulations to calculate overall uncertainties.

### 5 Experimental Results

### 5.1 Measured Soot Emission Rates

FIG. 4A shows a sketch of a sample instantaneous greyscale image of the flare and plume from the demonstration measurements. The black circular arc (6 m radius from the center of the flare tip) illustrates the control surface used when evaluating the soot emission rate. Although the intensity scale of the plotted image allows the plume to be easily identified, to the naked eye the plume was barely apparent. The measured plume transmissivity τₑₓₚ (background of FIG. 4B) was generally above 86% at all locations within the turbulent plume, and average values along profiles through plume were typically in the range of 96%. The ability of the current apparatus to accurately discern such high transmissivities illustrates very good sensitivity for low soot concentrations.

FIG. 4B shows a representation of the measured velocity field superimposed on the transmissivity image τₑₓₚ for the same raw image frame sketched in FIG. 4A. The measured velocities within the plume were in the range of 1.0 to 2.5 m/s, consistent with the ambient wind conditions. The 6 m radius arc centred on the stack tip indicates the control surface used to evaluate time-resolved soot emission rates. Total soot emission across the surface was obtained by integrating the local values of u(y)(−ln [τ*(y)]) following eq. (15).

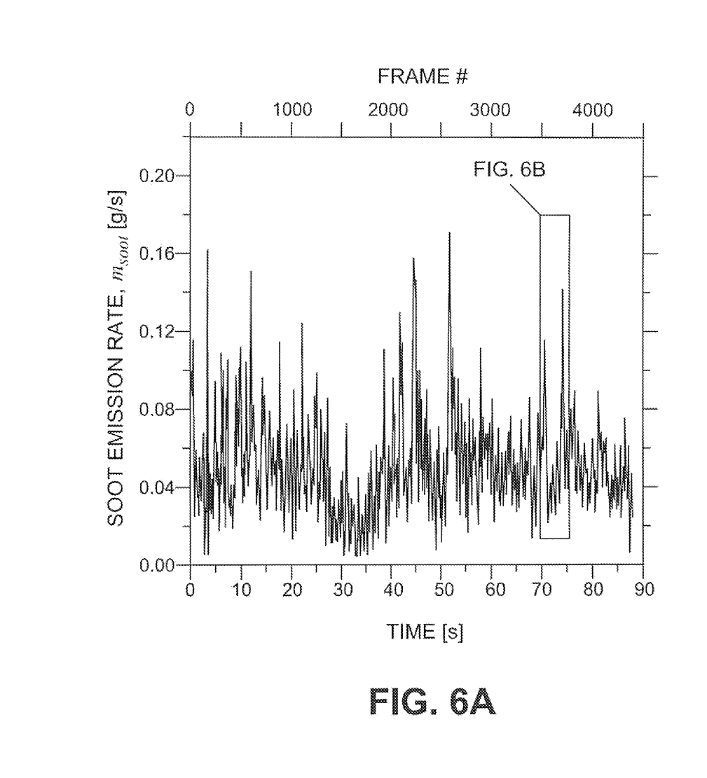

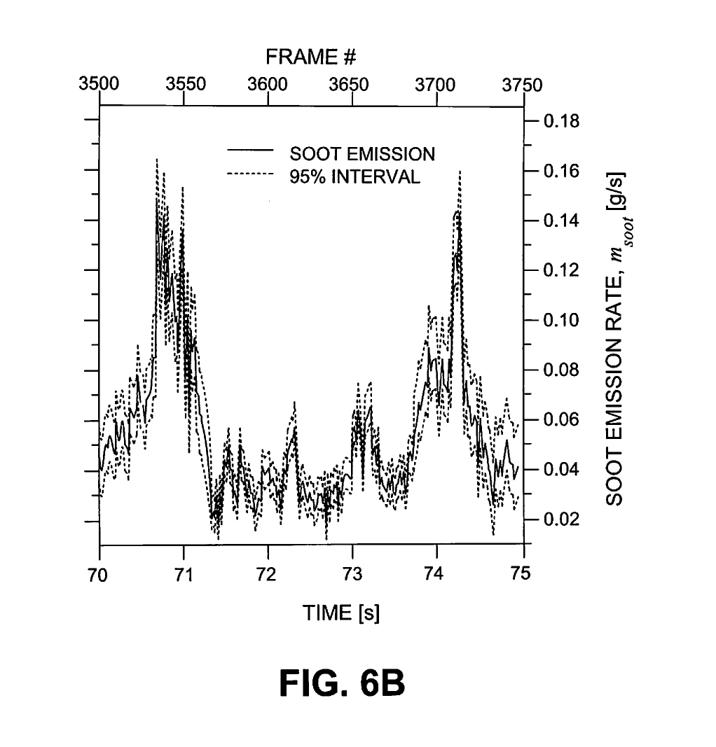

FIGS. 6A and 6B show a sample plot of the time-resolved, total soot emission rate (integrated along the control surface) as measured via sky-LOSA. Data shown are for a 4500-frame image series spanning 90 s of physical time. FIG. 6A shows a soot emission rate over the complete acquisition (4500 frames at 50 fps, e.g. 90 s). FIG. 6B shows a zoomed plot of 5 s of acquisition, including the 95% confidence interval on uncertainty discussed herein.

As apparent in FIG. 6A, \dot{m}ₛₒₒₜ fluctuated between 0.01 g/s and 0.15 g/s over the 90 s of acquisitions. FIG. 6b shows a zoomed 5 s segment of the same time series overlaid on the calculated 95% uncertainty limits as further discussed below. These plots help demonstrate that the current sCMOS-camera based sky-LOSA system is able to accurately track the turbulent motion of the plume and instantaneous fluctuations in emissions. Averaging across all acquired frames corresponding to approximately ten minutes of measurements spread over a 1.5 hour period as summarized in the table of FIG. 5, the mean soot emission rate for the flare in the demonstration case, was 0.053 g/s with a 95% uncertainty interval of 0.045 g/s 0.064 g/s.

### 5.2 Evaluation of Uncertainties

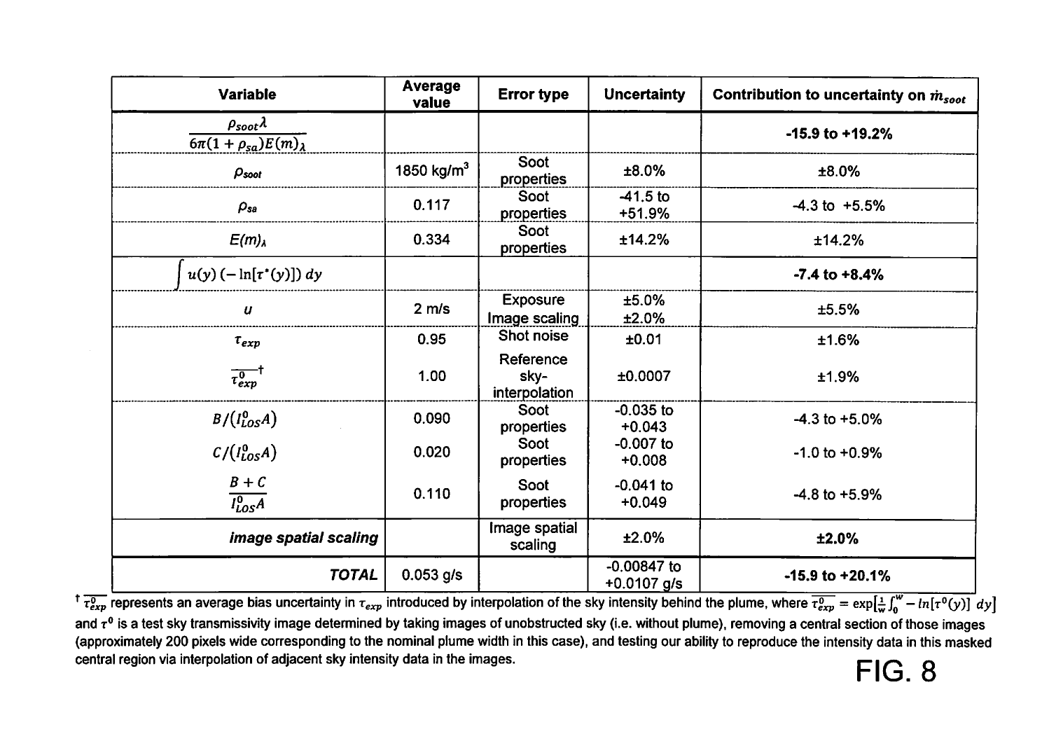

FIG. 8 shows Table 3, which summarizes the results of the Monte Carlo simulations to quantify total and component uncertainties in the demonstration sky-LOSA measurement of soot emission rates. Table 3 is divided into subsections consistent with the groupings of terms used to calculate \dot{m}ₛₒₒₜ via eq. (15). As with all optical diagnostics for measuring particulate matter, the quantification of soot emission rates from sky-LOSA signals strongly depends on soot properties which are not always well characterized. In the present case, uncertainties in optical and morphological properties of soot are the largest contributor to the overall uncertainties, equating to an asymmetric (lognormally distributed)-15.9% to +20.1% uncertainty in the absolute measured value of \dot{m}ₛₒₒₜ. However, for measurements specifically intended to discern differences among flow conditions or groups of comparable flares burning similar fuels where soot properties could be considered effectively constant among measurements, then the uncertainties in soot property data have the limited effect of introducing a common scaling bias for all measurements. In this case, the relative uncertainty in comparable measurements would be less than approximately 6%, and dominated by velocity measurement error as illustrated in FIG. 8.

The middle section of Table 3 (FIG. 8) itemizes uncertainty contributions for terms inside the integral of eq. (15) associated with the measurement of transmissivity and velocity. Notably, the contribution of the conditional-average based sky-interpolation process (represented by τ̅ₑ̅ₓ̅ₚ̅⁰̅ in the table) to the final uncertainty in the measured soot emission rate (\dot{m}ₛₒₒₜ) is only ±1.9%. Consequently the uncertainty of ∫u(y)(−ln [τ*(y)]) dy is mostly influenced by the velocity uncertainty, which is primarily due to the plume displacement during the 1 ms exposure time of each frame relative to the typical displacement between 2 successive frames (used for ICV). Since the ICV processing was performed at 50 fps for all series, this equates to an uncertainty of ±5.0%. Coupled with the modest spatial scaling uncertainty of ±2.0% (laser rangefinder uncertainty of ±1.0 m at distances of 46 m and 68 m), the overall velocity uncertainty is then ±5.5%. Thus, enabled by the conditional-average-enhanced interpolation algorithm, the uncertainty of ∫u(y)(−ln [τ*(y)]) dy is −7.4% to +8.4%, whereas it was ±29.0% in (Johnson et al., 2011).

### 5.3 Analysis of Influence of In-Scattering and Sky-Models on Calculated Emission Rates

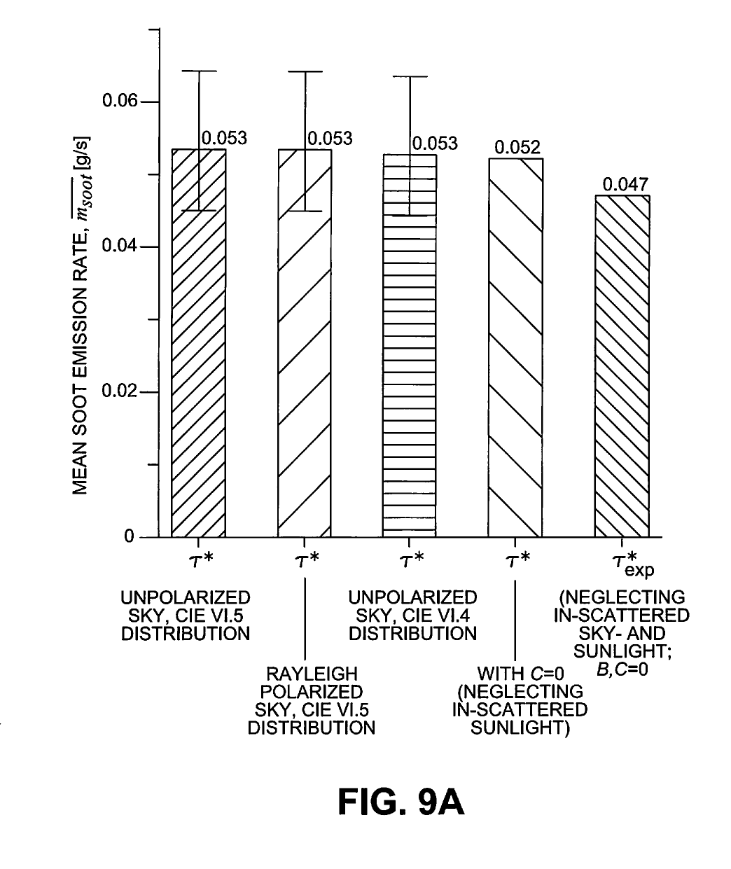

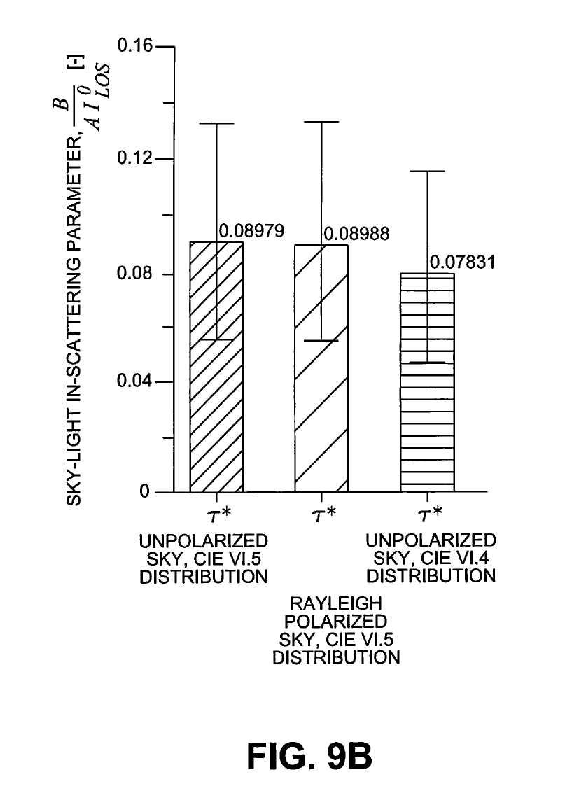

FIGS. 9A and 9B evaluate the influence of various model assumptions used to quantify the effects of in-scattered light when computing τ* from τₑₓₚ via eq. (16) (as a step on the process of calculating soot emission rates via eq. (15)). FIG. 9A compares the effect of different model assumptions on the final mass emission rate whereas FIG. 9B illustrates the associated influence on the sky-light in-scattering parameter, B/(I_{LOS}⁰A).

### 5.3.1 Influence of Sky-Polarization State and Intensity Distribution

In-scattered sky-light was considered for two limiting cases of the sky polarization distribution: completely unpolarized and maximally polarized according to molecular Rayleigh scattering theory. The unpolarized case simplifies the calculation and reduces eq. (39) of the Section 5 to eq. (φ) since I_{sky}(α,Z)ᵥ=I_{sky}(α,Z)ₕ. For the maximally polarized case, the polarization distribution over the sky-dome was evaluated assuming polarization via molecular Rayleigh scattering, which induces a variation in the angle and degree of polarization as a function of the scattering angle between the sun axis and the sky portion (α,Z). Since pure Rayleigh scattering would lead to a maximum polarization degree of 100%, this conservatively overestimates the amount of actual sky polarization which is usually less than 70% (Pust and Shaw, 2008). These two cases were used to evaluate the sensitivity of the soot emission rate calculation to sky-dome polarization (via influence on the parameter B/(I_{LOS}⁰A) as it appears in eq. (16), whether derived using either eq. (φ) or eq. (39)).

As shown in FIG. 9B, the bounding polarization states make a trivial change in the sky-light in-scattering parameter B/(I_{LOS}⁰A) (0.08979 for unpolarized vs. 0.08988 for fully polarized) and negligible difference in the actual measured soot emission rate. This is an encouraging finding both for the robustness of the calculation and for the ability to appropriately simplify calculations by considering the unpolarized case only, as presented with eq. (φ).

The importance of the angular distribution of sky-light intensity was also considered. For the results as presented, the in-scattering parameter B/(I_{LOS}⁰A) was calculated using the CIE/ISO clear sky VI.5 model (CIE, 2003) for the spatial distribution of sky-light. The CIE VI.5 distribution was chosen since it closely matched the sky-light variations with Zenith angle over the acquired plume frame to within 7%. As illustrated in FIG. 9A, using a different CIE clear sky intensity distribution model had only a modest effect on the magnitude of the in-scattering parameter B/(I_{LOS}⁰A), much less than the uncertainty range attributable to potential optical property variations. More importantly, the effect of sky-light distribution model was negligible on the final calculated soot emission rate as indicated in FIG. 9A. Re-evaluating B/(I_{LOS}⁰A) as the zenith angle of the sun moved from 42.5° to 46.5° during measurements similarly showed a negligible variation of only 0.1%.

5.3.2 Net Influence of In-Scattered Light from the Skydome and Sun

As indicated in FIGS. 9A and 9B and further detailed in Table 3 (FIG. 8), while the uncertainties are quite large for the calculated magnitudes of the sky-light in-scattering parameter, B/(I_{LOS}⁰A), and the sunlight inscattering parameter, C/(I_{LOS}⁰A), the impact of both of these parameters on the measured soot emission rate is damped in the derived equations.

Using the CIE clear sky model VI.5, the 95% confidence interval in the uncertainty for is 0.055-0.133 which is equivalent to an accuracy of −39% to +48% on the averaged value of 0.090. However, the effect of this term is a comparatively small adjustment to the value of τ* relative to τₑₓₚ, such that the final uncertainty in the calculated soot emission rate due to the uncertainty in B/(I_{LOS}⁰A) is only −4.3% to +5.0%.

The sunlight in-scattering parameter, C/(I_{LOS}⁰A), was also calculated as part of the Monte Carlo analysis using the same draws of soot optical and morphology data used in the calculation of B/(I_{LOS}⁰A) in addition to the measured sunlight irradiance Eₛᵤₙ. The measured Eₛᵤₙ/I_{LOS}⁰ ratio was 0.1 ster leading to an average C/(I_{LOS}⁰A) of 0.020, with a 95% confidence interval in the uncertainty of 0.013 to 0.028 (−34% to +40%). However, as the absolute value of this ratio is quite small, the net impact on the uncertainty in the measured soot emission rate uncertainty is again negligible at approximately ±1.0%.

An implication of these results is that for the demonstration measurement conditions encountered in Poza Rica, the intensity of direct sun-light scattering by the plume was lower than the intensity of in-scattered light from the complete sky-dome (C<B). As indicated on FIGS. 9A and 9B, neglecting the influence of sunlight scattering in the plume (i.e. assuming C=0 in calculations), would have a negligible effect on the measured soot emission rate in the present case. Furthermore, since the value of (B+C)/(I_{LOS}⁰A) was small at 0.110, this means that in the present case the overall intensity of both in-scattered skylight and sunlight was small relative to the sky intensity behind the plume. As such, soot emission rates calculated ignoring both effects (i.e. assuming B, C=0) would results in a modest underestimation of the soot emission rate by only 13% as seen on FIGS. 9A and 9B.

It is important to note that the impact of in-scattering of both skylight and sunlight would not always be small and correction for these effects using the generalized theory presented here would be more critical in other measurement conditions. In the present case, the contribution of direct sun-light scattering was minimized by the position of the sun behind the camera. However, since the alignment of the optical axis during field measurements is usually dictated by the direction of plume travel, preferred positioning of the sun cannot be guaranteed. The effect of sunlight scattering becomes non-negligible as the sun approaches a position behind the plume and/or the relative intensity of the sun in the sky increases (e.g. via lower atmospheric turbidity). For a hypothetical condition where the angle between the camera axis and the sun position was 10°, the magnitude of C/(I_{LOS}⁰A) would be 6 times larger than in the conditions experienced at Poza Rica. Neglecting in-scattering of sunlight for this hypothetical case would lead to a 13% underestimation of the soot emission rate. Overall, the behaviour of the derived governing equations for a generalized sky-LOSA method shows that corrections for in-scattering are robust and with this approach accurate measurements are possible in a range of possible conditions.

### 6 Calculating Absorption and Scatter Cross-Sections of Soot Aggregates

As discussed in the detailed review by (Sorensen, 2001), soot aggregates may be accurately modelled using RDG-FA theory (Köylü and Faeth, 1994a; Dobbins and Megaridis, 1991; Bohren and Huffman, 1983). In this model, soot particles are described as fractal aggregates of spherical primary particles (monomers) and the number of primary particles in the aggregate, N, and the radius of gyration of the aggregate, R_{g}, is described by the relationship (Forrest and Witten, Jr., 1979):

$$N = {k}_{f} ( \frac{{R}_{g}}{{d}_{p} \text{/} 2} ) {D}_{f} \qquad ( 21 )$$

where k_{f} and D_{f} are the non-dimensional fractal prefactor and exponent and dₚ is the primary particle diameter [m]. RDG-FA theory is based on the assumptions that each primary particle acts independently (i.e., there is no multiple scattering) and that each particle is equally exposed to the incident light (i.e., there is negligible shielding of particles by other particles). This theory is widely used in soot diagnostics to model scattering from fractal soot aggregates and has been shown in direct simulations to have better than 10% accuracy in calculating the total scattering coefficient when the primary particles fall within the Rayleigh limit (xₚ=πdₚ/λ<<1, taken as xₚ<0.3) and the fractal exponent is less than or equal to 2 (Farias et al., 1996).

### 6.1 Absorption Cross-Section

From RDG-FA, the absorption cross-section of a single primary particle is (Sorensen, 2001):

$${σ}_{pp}^{abs} = \frac{{π}^{2} {d}_{p}^{3}}{λ} E ( {m}_{λ} ) [ {m}^{2} ] \qquad ( 22 )$$

where λ is wavelength [m] and

$$E ( {m}_{λ} ) = Im ( \frac{{m}^{2} - 1}{{m}^{2} + 1} )$$

is the retractive index light absorption function [−], and m is the complex index of refraction. The absorption cross-section of an aggregate [m²] is simply the absorption cross-section of a primary particle multiplied by the number of primary particles in the aggregate, N. Thus the effective aggregate absorption cross-section, σ̅_̅{̅a̅g̅g̅}̅^̅{̅a̅b̅s̅}̅, (i.e. the absorption cross-section of the weighted-average aggregate) is (Dobbins and Megaridis, 1991):

σ̅_̅{̅a̅g̅g̅}̅^̅{̅a̅b̅s̅}̅=∫₁^{≈}σₚₚ^{abs}P(N)NdN= N̅σₚₚ^{abs}[m²] (23)

where P(N) is a probability distribution function describing the size distribution of the aggregates (i.e. distribution of number of primary particles per aggregate) and N̅ is the average number of primary particles per aggregate.

### 6.2 Scattering Cross-Section

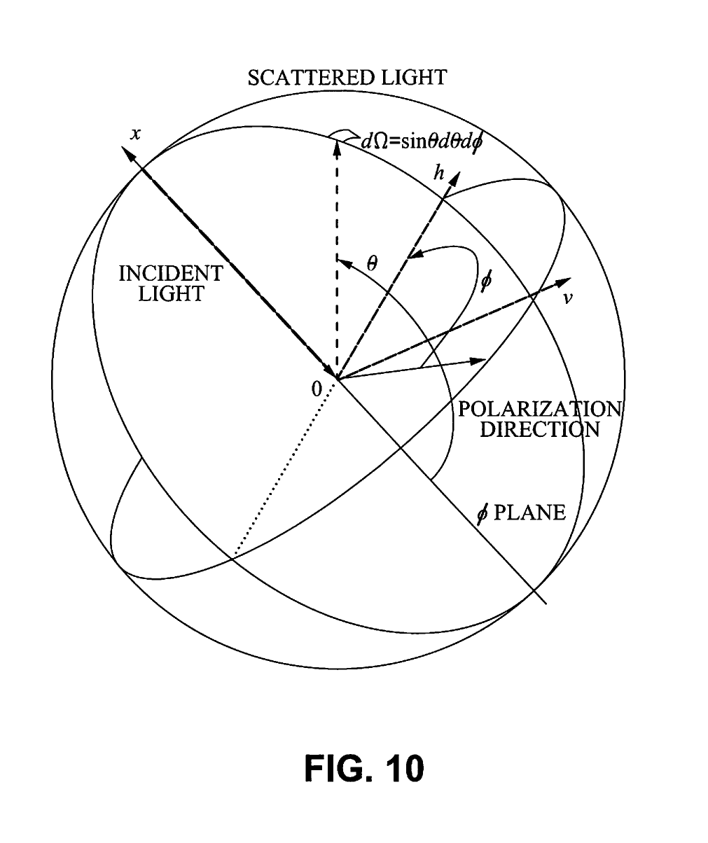

The intensity of elastic light scattering from particles is dependent on the polarization direction of the incident and scattered light. Although light polarization can include a rotational component, it is negligible in the case of sky-light (Prosch et al., 1983). Linear light polarization is often described in terms of horizontally and vertically polarized components, where horizontal polarization refers to oscillations within the plane defined by the incident and scattered light vectors, and vertical polarization refers to oscillations normal to this plane. Scattering cross-sections are consequently defined using a pair of subscript characters, where the first character indicates the polarization direction (h=horizontal or v=vertical) of the incident light and the second indicates the polarization direction of the scattered light (e.g. vh stands for vertically polarized incident light and horizontally polarized scattered light). The differential scattering cross section of a primary particle is thus comprised of four components vv, hh, hv and vh. Since the hv and vh cross sections are less than 3% of the vv cross-section (Köylü and Faeth, 1994b), they can be neglected. The differential horizontal-horizontal (hh) scattering cross-section scales with the differential vertical-vertical (vv) scattering cross-section as (Köylü and Faeth, 1994b):

$$\frac{d {σ}_{pp}^{sca}}{d {Ω}_{hh}} = \frac{d {σ}_{pp}^{sca}}{d {Ω}_{vv}} {cos}^{2} θ [ {m}^{2} {ser}^{- 1} ] \qquad ( 24 )$$

where θ is the scattering angle defined in FIG. 1, i.e. the angle between incident light vector and the scattered light vector under consideration, and dΩ is the differential solid angle (see FIG. 10).

The differential vv scattering cross-section of a primary particle is (Sorensen, 2001):

$$\frac{d {σ}_{pp}^{sca}}{d {Ω}_{vv}} = \frac{{π}^{4} {d}_{p}^{6}}{4 {λ}^{4}} F ( {m}_{λ} ) [ {m}^{2} {ster}^{- 1} ] \qquad ( 25 )$$

where F(m_{λ}) is the refractive index light scattering function.

The differential vv scattering cross-section of an aggregate of size N is (Sorensen, 2001):

$$\frac{d {σ}_{agg}^{sca}}{d {Ω}_{vv}} = \frac{d {σ}_{pp}^{sca}}{d {Ω}_{vv}} {N}^{2} S ( q ( θ ) {R}_{g} ( N ) , {D}_{f} ) [ {m}^{2} {ster}^{- 1} ] , \qquad ( 26 )$$

where S is a shape factor which is defined as (Sorensen, 2001):

$$S ( {qR}_{g} , {D}_{f} ) = exp ( - \frac{{( {qR}_{g} )}^{2}}{{D}_{f}} ) {}_{1}^{}{F}{}_{1}^{} ( \frac{3 - {D}_{f}}{2} , \frac{3}{2} , \frac{{( {qR}_{g} )}^{2}}{{D}_{f}} ) \qquad ( 27 )$$

The shape factor employs the confluent hypergeometric function ₁F₁ and is dependent on q, the magnitude of the scattering wave vector \vec{q}:

$$q = \frac{4 π}{λ} sin ( \frac{θ}{2} ) [ {m}^{- 1} ] \qquad ( 28 )$$

The effective aggregate differential vv scattering cross-section (i.e. averaged over the aggregate-size distribution P(N)) is then obtained by the following probability-weighted integration:

$$\frac{\overline{d {σ}_{agg}^{sca} ( θ )}}{d {Ω}_{vv}} = {\int }_{1}^{∞} \frac{d {σ}_{pp}^{sca}}{d {Ω}_{vv}} P ( N ) {N}^{2} S ( q ( θ ) {R}_{g} ( N ) , {D}_{f} ) d N [ {m}^{2} {ster}^{- 1} ] \qquad ( 29 )$$

Similarly, from (24) and (29), the effective aggregate differential hh scattering cross-section is:

$$\overline{\frac{d {σ}_{agg}^{sca} ( θ )}{d {Ω}_{hh}}} = {cos}^{2} θ \overline{\frac{d {σ}_{agg}^{sca} ( θ )}{d {Ω}_{vv}}} [ {m}^{2} {ster}^{- 1} ] \qquad ( 30 )$$

### 6.3 Effective Total Scattering Cross-Section

The effective aggregate total scattering cross-section is used to quantify the amount of light that is scattered away in all directions for a given ray of incident light. Quantification of the total scattering is necessary to obtain the absorption coefficient from extinction measurements (where extinction is equal to absorption plus total scattering). In general, to calculate total scattering, the degree of polarization, χₚₒₗ, and polarization angle, δ_{w}, of the incoming light must be considered. This is true in the present case since incoming sky light may be partially polarized (i.e. comprised of both non-polarized and linearly polarized components).

FIG. 10 defines the geometry used in the scattering calculations. Scattering takes place at the origin 0 with incident light coming along the x axis. The incident light is partially polarized with a linearly-polarized fraction in the direction indicated. The scattering angle θ is defined so that forward scattering is obtained for θ=0 which is the usual convention. The angle θ is identical to the θ defined in FIG. 1.

The vertical and horizontal components of incident light from a partially polarized source are equal to (Walraven, 1981):

Iᵥ=½(1−χₚₒₗ)+I_{χ}_{ₚₒₗ} sin²(φ) (31)

Iₕ=½(1−χₚₒₗ)+I_{χ}_{ₚₒₗ} cos²(φ) (32)

Following (Sorensen, 2001), but considering partially polarized incident light, the effective aggregate total scattering cross-section is:

$$\overline{{σ}_{agg}^{sca}} = {\int }_{0}^{π} {\int }_{0}^{2 π} \overline{\frac{d {σ}_{agg}^{sca} ( θ )}{d {Ω}_{vv}}} [ ( \frac{( 1 - {𝒳}_{pol} )}{2} + {𝒳}_{pol} {sin}^{2} ( φ ) ) + ( \frac{( 1 - {𝒳}_{pol} )}{2} + {𝒳}_{pol} {cos}^{2} ( φ ) ) {cos}^{2} θ ] sin θ d φ d θ [ {m}^{2} ] \qquad ( 33 )$$

where the term sin θ dφdθ correspond to the elementary solid angle dΩ. The integration over φ with limits of 0 and 2π radians causes χₚₒₗ to drop out and the expression which then simplifies to:

$$\overline{{σ}_{agg}^{sca}} = π {\int }_{0}^{π} \overline{\frac{d {σ}_{agg}^{sca} ( θ )}{d {Ω}_{vv}}} ( 1 + {cos}^{2} ( θ ) ) sin θ d θ [ {m}^{2} ] \qquad ( 34 )$$

6.4 Scattering of Partially Polarized Sky-Light Along the Optical Axis of the Sky-LOSA Measurement (In-Scattering Along the x-Axis)

Sky-light principally results from Rayleigh scattering of sun-light and is usually partially polarized. The degree of linear polarization, χ_{sky}, varies over the sky-dome and is thus a function of both α and Z as defined in FIG. 1. Pure Rayleigh scattering would lead to 100% linear polarization at scattering angles of 90° from the sun; however, χ_{sky} usually remains below 70% (Pust and Shaw, 2008) due to dust and other atmospheric particulates which reduce the degree of polarization. The strongest sky-light polarization is obtained for clear-sky conditions with low turbidity, while pollution and clouds significantly reduce the maximum degree of polarization (to below 40% to 50% for polluted atmospheres (Coulson, 1971; Pust and Shaw, 2012) and below 30% in the presence of clouds (Pust and Shaw, 2008)).

Following eq. (27) and (28) above, for the general case of partially polarized sky-light, the intensity of a solid angle of the sky-dome (as a function of α and Z) can be separated into the intensity of vertically and horizontally polarized components that are calculated as follows:

$$\begin{matrix}{{I}_{sky} ( α , Z )}_{v} = \frac{{I}_{sky}}{2} [ 1 - {𝒳}_{sky} ] + {I}_{sky} {𝒳}_{sky} {cos}^{2} ( {φ}_{sky} ) & ( 35 ) \\ {{I}_{sky} ( α , Z )}_{h} = \frac{{I}_{sky}}{2} [ 1 - {𝒳}_{sky} ] + {I}_{sky} {𝒳}_{sky} {sin}^{2} ( {φ}_{sky} ) & ( 36 )\end{matrix}$$

where χ_{sky} is the degree of polarization and φ_{sky} is the polarization angle, and both are functions of α and Z.

As introduced in FIG. 1 and eq. (1), a fraction of the light originating from each portion of the sky dome is scattered along the optical axis of the sky-LOSA measurement by soot aggregate in the plume, creating in-scattering. Employing the scattering cross-sections defined in eq. (25) and (26), the vv and hh components of the in-scattering from location (α, Z) on the sky-dome by an elemental section of plume dx, are:

$$\begin{matrix}d {{I}_{sky}^{sc , in} ( x )}_{vv , α , Z} = ( {{I}_{sky} ( α , Z )}_{v} \frac{\overline{d {σ}_{agg}^{sca} ( θ ( α , Z ) )}}{d {Ω}_{vv}} sin Z d α d Z ) n ( x ) d x & ( 37 ) \\ d {{I}_{sky}^{sc , in} ( x )}_{hh , α , Z} = ( {{I}_{sky} ( α , Z )}_{h} \frac{\overline{d {σ}_{agg}^{sca} ( θ ( α , Z ) )}}{d {Ω}_{vv}} {cos}^{2} θ ( α , Z ) sin Z d α d Z ) n ( x ) d x & ( 38 )\end{matrix}$$

where the term sin Z dadZ accounts for the solid angle of the elementary sky portion at location (α,Z). It is noted that the orientation of vertical and horizontal polarization components of the sky intensity, I_{sky}(α,Z)ᵥ and I_{sky}(α,Z)ₕ, are defined relative to the plane defined by the incident and scattered light and thus vary with α and Z over the sky dome.

Combining the vv and hh components and integrating to account for in-scattering of light originating over the whole sky-dome, the total intensity of in-scattered sky-light by soot aggregates in an elemental section of plume, dx, is then:

$${dI}_{sky}^{sc , i n} ( x ) = ( {\int }_{0}^{\frac{π}{2}} {\int }_{0}^{2 π} [ \begin{matrix}{{I}_{sky} ( α , Z )}_{v} \overline{{\frac{d {σ}_{agg}^{sca} ( θ ( α , Z ) )}{d Ω} }_{vv}} + \\ {{I}_{sky} ( α , Z )}_{h} \overline{{\frac{d {σ}_{agg}^{sca} ( θ ( α , Z ) )}{d Ω} }_{vv}} {cos}^{2} θ ( α , Z )\end{matrix} ] sin Z d α d Z ) n ( x ) dx \qquad ( 39 )$$

If the assumption is made that the incoming light is unpolarized, the expression simplifies to the form shown in eq. (φ).

### 7 Conclusions

A generalized method using a sky-LOSA measurement has been derived that enables accurate measurement of soot mass flux within an atmospheric flare plume in the presence of in-scattered light from the sun and skydome. Developed using RDG-FA theory, the derived equations allow experimentally-measured transmissivity data to be directly related to an idealized transmissivity in the absence of in-scattering, where the latter can then be used to accurately quantify soot mass emission rates. Application of this new theory in demonstration measurements using field data collected from a lightly-sooting gas flare in Mexico has shown the robustness of the approach, where calculations were shown to be insensitive to assumptions about the sky-polarization state and precise intensity distribution. In these demonstration measurements, very good measurement sensitivity was demonstrated on a flare producing soot emissions that were only marginally visible to the naked eye. A Monte Carlo uncertainty analysis revealed soot morphology and optical properties as the largest uncertainty contributor, as is the case with most optical diagnostics. The mean emission rate of 0.053 g/s was estimated to be equivalent to the emissions of 14 buses continuously driving, and was approximately 36 times less than that of the only other operating flare measured to date, a 1 m diameter, visibly sooting flare in Uzbekistan. The difference between these flares is illustrative of the variation among different types of flares under myriad operating conditions globally. The ability of the generalized sky-LOSA method to accurately quantify these broadly varying emission rates underscores its value as a unique technology, enabling the acquisition of critical data for this potentially significant global source of black carbon emissions. While Sky-LOSA has been developed as a solution to the specific measurement challenge of quantifying mass emission rates of soot from oil and gas flares, the technique has the potential to enable quantitative measurements in a broader range of applications. These could include remote emission measurements from industry stacks, ships, or biomass burning.

Although the present application discloses example methods and apparatus including, among other components, software executed on hardware, such methods and apparatus are merely illustrative and should not be considered as limiting. For example, any or all of these hardware and software components could be embodied exclusively in hardware, exclusively in software, exclusively in firmware, or in any combination of hardware, software, and/or firmware. Accordingly, while example methods and apparatus are described herein, persons having ordinary skill in the art will appreciate that the examples provided are not the only ways to implement such methods and apparatus.

Furthermore, the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, removable memory connected via USB, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD, and Blu Ray™. Processors and program code for implementing aspects of the technology described herine can be centralized or distributed (or a combination thereof).

### REFERENCES

Andreae, M. O. and Gelencsér, A. (2006). Black carbon or brown carbon? The nature of light-absorbing carbonaceous aerosols. Atmos. Chem. Phys. 6:3131-3148.
Arctic Council (2011). Arctic Council Task Force on Short-Lived Climate Forcers Progress Report and Recommendations for Ministers, Nuuk Greenland. Arctic Council Task Force on Short-Lived Climate Forcers. Available at: http://arctic-council.npolar.no/accms/export/sites/default/en/meetings/2011-nuuk-ministerial/docs/3-0a_TF_SPM_recommendations_{—}2May11_final.pdf
Bohren, C. F. and Huffman, D. R. (1983). Absorption and Scattering of Light by Small Particles. New York, Wiley.
Bond, T. C. and Bergstrom, R. W. (2006). Light Absorption by Carbonaceous Particles: An Investigative Review. Aerosol Sci. Technol. 40:27-67.
Bond, T. C., Doherty, S. J., Fahey, D. W., Forster, P. M., Berntsen, T., DeAngelo, B. J., Flanner, M. G., Ghan, S., Karcher, B., Koch, D., et al. (2013) Bounding the role of black carbon in the climate system: A scientific assessment. Journal of Geophysical Research: Atmospheres, in press (doi: 10.1002/jgrd.50171)
Bond, T. C., Wehner, B., Plewka, A., Wiedensohler, A., Heintzenberg, J., and Charlson, R. J. (2006). Climate-relevant properties of primary particulate emissions from oil and natural gas combustion. Atmos. Environ. 40:3574-3587.
CIE (2003). Spatial Distribution of Daylight—CIE Standard General Sky. CIE S 011/E:2003; ISO 15469:2003(E), Vienna, Austria, Commission Internationale de l'Eclarage.
Cai, J., Lu, N., and Sorensen, C. M. (1993). Comparison of Size and Morphology of Soot Aggregates As Determined by Light Scattering and Electron Microscope Analysis. Langmuir. 9:2861-2867.
Cai, J., Lu, N., and Sorensen, C. M. (1995). Analysis of fractal cluster morphology parameters: structural coefficients and density autocorrelation function cutoff. J. Colloid Interface Sci. 171:470-473.
Chang, H. and Charalampopoulos, T. T. (1990). Determination of the Wavelength Dependence of Refractive Indices of Flame Soot. P. R. Soc., A. 430:577-591.
Choi, M. Y., Hamins, A., Mulholland, G. W., and Kashiwagi, T. (1994). Simultaneous optical measurement of soot volume fraction and temperature in premixed flames. Combust. Flame. 99:174-186.
Choi, M. Y., Mulholland, G., Hamins, A., and Kashiwagi, T. (1995). Comparisons of the Soot Volume Fraction Using Gravimetric and Light Extinction Techniques. Combust. Flame. 3.02:161-169.
Coderre, A. R., Thomson, K. A., Snelling, D. R., and Johnson, M. R. (2011). Spectrally-Resolved Light Absorption Properties of Cooled Soot from a Methane Flame. Appl. Phys. B. 104:175-188.
Coulson, K. L. (1971). On the solar radiation field in a polluted atmosphere. Journal of Quantum Spectroscopy and Radiative Transfer. 11:739-755,
De Iuliis., S., Maffi, Cignoli, F., and Zizak, G. (2011). Three-angle scattering/extinction versus TEM measurements on soot in premixed ethylene/air flame. Appl. Phys. B. 102:891-903.

Di Stasio, S, (2000). Feasibility of an optical experimental method for the sizing of prima y spherules in sub-micron agglomerates by polarized light scattering. Appl. Phys. B. 70:635-643.

Dobbins, R. A. and Megaridis, C. (1991), Absorption an scattering of light by polydisperse aggregates. Appl. Opt. 30; 4747-4754,
Dobbins, R. A., Mulholland, G. W., and Bryner, N. P. (1994). Comparison of a fractal smoke optics model with light extinction measurements. Atmos. Environ. 28:889-897,
Farias, T. L., Köylü, Ü. Ö., and Carvalho, M. G. (1996), Range of validity of the Rayleigh-Debye-Gans theory for optics of fractal aggregates. Appl. Opt. 35:6560-6567.
Forrest, S, and Witten, Jr., T. A. (1979), Long-range correlations in smoke-particle aggregates. J. Phys. A Math. Gen. 109:L109-L117.
Greenberg, P. S. and Ku, J. C. (1997), Soot volume fraction imaging. Appl. Opt, 36:5514-5522.
IPCC (2007). Climate Change 2007: The Physical Science Basis, Contribution of Working Group I to the Fourth Assessment Report of the Intergovernmental Panel on Climate Change. In S. Solomon, D. Qin, M. Manning, Z. Chen, M. Marquis, K. B. Averyt, M. Tignor, O, H. L. Miller, eds. Cambridge, UK and New York, USA, Cambridge University Press, p. 996,
Iyer, S., Litzinger, I., Lee, S., and Santoro, R. (2007), Determination of soot scattering coefficient from extinction and three-angle scattering in a laminar diffusion flame. Combust. Flame. 149:206-216.
Jacobson, M. Z. (2010), Short-term effects of controlling fossil-fuel soot, biofuel soot and gases, and methane on climate, Arctic ice, and air pollution health. J. Geophys. Res. 115.
Jensen, K. A., Suo-Anttila, J. M., and Blevins, L. G. (2007). Measurement of Soot Morphology, Chemistry, and Optical Properties in the Visible and Near-Infrared Spectrum in the Flame Zone and Overfire Region of Large Jp-8 Pool Fires. Combust. Sci. Technol. 179:2453-2487.
Johnson, M. R., Devillers, R. W., and Thomson, K. A. (2011). Quantitative Field Measurement of Soot Emission from a Large Gas Flare Using Sky-LOSA. Environ. Sci. Technol. 45:345-350.
Johnson, M. R., Devillers, R. W., Yang, C., and Thomson, K. A. (2010). Sky-Scattered Solar Radiation Based Plume Transmissivity Measurement to Quantify Soot Emissions from Flares. Environ. Sci. Technol. 44:8196-8202.
Keogh, D. U., Kelly, J., Mengersen, K., Jayaratne, R., Ferreira, L., and Morawska, L. (2010). Derivation of motor vehicle tailpipe particle emission factors suitable for modelling urban fleet emissions and air quality assessments. Environ. Sci. Pollut. Res. 17:724-739.
Krishnan, S. S., Lin, K.-C., and Faeth, G. M. (2000). Optical Properties in the Visible of Overfire Soot in Large Buoyant Turbulent Diffusion Flames. J. Heat Transfer. 122:517-524.

Köylü, Ü. Ö. and Faeth, G. M. (1992). Structure of overfire soot in buoyant turbulent diffusion flames at long residence times. Combust. Flame. 89:140-156.
Köylü, Ü. Ö. and Faeth, G. M. (1994a). Optical properties of overfire soot in buoyant turbulent diffusion flames at long residence times. J. Heat Transfer. 116:152-159.
Köylü, Ü. Ö. and Faeth, G. M. (1994b). Optical-properties of soot in buoyant laminar diffusion flames. J. Heat Transfer. 116:971-979.
Köylü, Ü. Ö. and Faeth, G. M. (1996). Spectral extinction coefficients of soot aggregates from turbulent diffusion flames. J. Heat Transfer. 118:415-421.
Köylü, Ü. Ö., Faeth, G. M., Farias, T. L., and Carvalho, M. G. (1995). Fractal and projected structure properties of soot aggregates. Combust. Flame. 100:621-633.
McEwen, J. D. N. and Johnson, M. R. (2012). Black Carbon Particulate Matter Emission Factors for Buoyancy Driven Associated Gas Flares. J. Air Waste Manage. Assoc. 62:307-321.

Medalia, A. I. and Richards, L. W. (1972). Tinting strength of carbon black. J. Colloid Interface Sci. 40:233-252.
Mullins, J. and Williams, A. (1987). The optical properties of soot: a comparison between experimental and theoretical values. Fuel. 66:277-280.
NOAA (2012). Global Gas Flaring Estimates. http://www.ngdc.noaa.govidmsp/interestigas_flares.html (accessed Jun. 29, 2012)
Ouf, F.-X., Vendel, J., Coppalle, A., Weill, M., and Yon, J. (2008). Characterization of Soot Particles in the Plumes of Over-Ventilated Diffusion Flames. Combust. Sci. Technol. 180:674-698.
Prosch, T., Hennings, D., and Raschke, E. (1983). Video polarimetry: a new imaging technique in atmospheric science. Appl. Opt. 22:4-7.
Pust, N. J. and Shaw, J. A. (2008). Digital all-sky polarization imaging of partly cloudy skies. Appl. Opt. 47:190-198.
Pust, N. J. and Shaw, J. a (2012). Wavelength dependence of the degree of polarization in cloud-free skies: simulations of real environments. Optics Expressxpress. 20:15559-68.
Schnaiter, M., Horvath, H., Mohler, O., Naumann, K., Saathoff, H., and Schack, O. (2003). UV-VIS-NIR spectral optical properties of soot and soot-containing aerosols. J. Aerosol Sci. 34:1421-1444.
Snelling, D. R., Link, O., Thomson, K. a., and Smallwood, G. J. (2011). Measurement of soot morphology by integrated LII and elastic light scattering. Appl. Phys. B. 104:385-397.
Snelling, D. R., Liu, F., Smallwood, G. J., and Guider, Ö. L. (2004). Determination of the soot absorption function and thermal accommodation coefficient using low-fluence LII in a laminar coflow ethylene diffusion flame. Combust. Flame. 136:180-190.
Snelling, D. R., Thomson, K. A., Smallwood, G. J., and Guider, Ö. L. (1999). Two-dimensional imaging of soot volume fraction in laminar diffusion flames. Appl. Opt. 38:2478-2485.
Sorensen, C. M. (2001). Light Scattering by Fractal Aggregates: A Review. Aerosol Sci. Technol. 35:648-687.
Sorensen, C. M., Cai, J., and Lu, N. (1992). Light-scattering measurements of monomer size, monomers per aggregate, and fractal dimension for soot aggregates in flames. Appl. Opt. 31:6547-6557.
Thomson, K. A., Johnson, M. R., Snelling, D. R., and Smallwood, G. J. (2008). Diffuse-light two-dimensional line-of-sight attenuation for soot concentration measurements. Appl. Opt. 47:694-703.
Tian, K., Thomson, K. A., Liu, F., Snelling, D. R., Smallwood, G. J., and Wang, D. (2006). Determination of the morphology of soot aggregates using the relative optical density method for the analysis of TEM images. Combust. Flame. 144:782-791.
U.S. Energy Information Administration (2012). International Energy Statistics. http://www.eia.gov/cfapps/ipdbproject/IEDIndex3.cfm (accessed Jun. 29, 2012)
US EPA (1990). Method 9—Visual Determination of the Opacity of Emissions from Stationary Sources. United States Environmental Protection Agency.
US EPA (2010). Integrated Science Assessment for Particulate Matter. EPA/600/R-08/139F, Research Triangle Park, NC, National Center for Environmental Assessmement-RTP Division, U.S. Environmental Protection Agency.
US EPA (2012). Report to Congress on Black Carbon. EPA-450/R-12-001, Research Triangle Park, NC, United States Environmental Protection Agency.
Walraven, R. L. (1981). Polarization imagery. Optical Eng. 20:14-18.
Wu, J.-S., Krishnan, S. S., and Faeth, G. M. (1997). Refractive indices at visible wavelengths of soot emitted from buoyant turbulent diffusion flames. J. Heat Transfer. 119:230-238.
Yang, B. and Koylu, U. O. (2005). Soot processes in a strongly radiating turbulent flame from laser scattering/extinction experiments. J. Quant. Spectrosc. Radiat. Transfer. 93:289-299.
Yon, J., Lemaire, R., Therssen, E., Desgroux, P., Coppalle, A., and Ren, K. F. (2011). Examination of wavelength dependent soot optical properties of diesel and diesel/rapeseed methyl ester mixture by extinction spectra analysis and LII measurements. Appl. Phys. B. 104:253-271.

1. A method of determining a spatially resolved reference transmissivity field (τ*) of an atmospheric plume, the method comprising:
obtaining a spatially resolved measurement of plume and adjacent skylight intensity (I_{LOS}^{M}) using an optical detection system, the optical axis for the measurement being the optical axis of the detection system, which transects the atmospheric plume and has an angle β relative to horizontal;
calculating an apparent transmissivity field (τₑₓₚ) as a ratio of spatially resolved I_{LOS}^{M} and I_{LOS}⁰ data where I_{LOS}⁰ is a spatially resolved reference background sky-intensity in a region of the sky behind the atmospheric plume;
calculating a relative contribution of in-scattered sky-light, B, in accordance with eq. 6b
$$\frac{B}{{I}_{LOS}^{0}} = \frac{1}{{I}_{LOS}^{0}} {\int }_{0}^{\frac{π}{2}} {\int }_{0}^{2 π} {I}_{sky} ( α , Z ) \overline{{\frac{d {σ}_{agg}^{sc} ( θ ( α , Z ) )}{d Ω} }_{vv}} ( \frac{1 + {cos}^{2} θ ( α , Z )}{2} ) sin Z d α d Z \qquad ( 6 b )$$
where
I_{sky}(α,Z) is a radiance originating from a location in the sky specified by angles α and Z [W M⁻²ster⁻¹];
α is an azimuth angle between a first plane and a second plane, the first plane containing the sun and a measurement zenith axis and the second plane containing a position in the sky of interest and the measurement zenith axis, where the azimuth angle is defined to be positive in a clockwise direction relative to the first plane when looking down to the surface of the earth and the measurement zenith axis is defined as a vertical axis relative to the surface of the earth originating at a measurement location;
Z is a zenith angle between a line connecting a position in the sky of interest and the measurement zenith axis, the zenith angle being equal to zero when the position of the sky is directly above the measurement location;
(α,Z) is an angle between a line connecting the measurement location and the position in the sky of interest, defined by the angles α and Z, and a second line defined by the optical axis of the optical detection system, the angle θ being equal to zero when the position in the sky is intersected by the optical axis;
$$\overline{{\frac{d {σ}_{agg}^{sc} ( θ ( α , Z ) )}{d Ω} }_{vv}}$$
is the effective differential scattering cross-section of a soot aggregate with respect to solid angle, Ω, and is a function of the scattering angle, θ [m² ster⁻¹] and the subscript ‘vv’ indicates vertical polarization of both the incident and scattered light;
calculating of a ratio of sun intensity to sky intensity behind the atmospheric plume
$$( \frac{{E}_{sun}}{{I}_{LOS}^{0}} )$$
using measured data for intensity of the sun in the sky;
calculating a contribution of in-scattered sun-light, C, in accordance with eq. 6c
$$\frac{C}{{I}_{LOS}^{0}} = \frac{{E}_{sun}}{{I}_{LOS}^{0}} \overline{{\frac{d {σ}_{agg}^{sc} ( {θ}_{sun} )}{d Ω} }_{vv}} \frac{1 + {cos}^{2} {θ}_{sun}}{2} \qquad ( 6 c )$$
where θₛᵤₙ is an angle between a line connecting the measurement location and the sun and a second line defined by the optical axis of the optical detection system, the angle θₛᵤₙ being equal to zero when the optical detection system's optical axis intersects the sun;
calculating the reference transmissivity in accordance with eq. 16
$${τ}^{*} = ( {τ}_{ex p} - \frac{B + C}{{I}_{LOS}^{0} \overline{{σ}_{agg}^{ext}}} ) {( 1 - \frac{B + C}{{I}_{LOS}^{0} \overline{{σ}_{agg}^{ext}}} )}^{- 1} \qquad ( 16 )$$
where σ̅_̅{̅a̅g̅g̅}̅^̅{̅e̅x̅t̅}̅ is the measured or calculated extinction coefficient of the target constituents of the plume at a specified measurement wavelength band; and
outputting the reference transmissivity to an output device.

2. The method of claim 1 where sky-light polarization variation is considered when calculating a relative contribution of in-scattered sky-light, B, via the following modified form of eq. 6b
$$\frac{B}{{I}_{LOS}^{0}} = \frac{1}{{I}_{LOS}^{0}} ( \begin{matrix}{\int }_{0}^{\frac{π}{2}} {\int }_{0}^{2 π} \\ [ \begin{matrix}{{I}_{sky} ( α , Z )}_{v} \overline{{\frac{d {σ}_{agg}^{sca} ( θ ( α , Z ) )}{d Ω} }_{vv}} + \\ {{I}_{sky} ( α , Z )}_{h} \overline{{\frac{d {σ}_{agg}^{sca} ( θ ( α , Z ) )}{d Ω} }_{vv}} {cos}^{2} θ ( α , Z )\end{matrix} ] sin Z d α d Z\end{matrix} ) \qquad ( 6 d )$$
where I_{sky}(α,Z) is vertically polarized sky-light and I_{sky}(α,Z)ₕ is horizontally polarized sky-light for the position in the sky of interest, defined by the angles α and Z.

3. The method of claim 1 wherein C is assumed to be zero.

4. The method of claim 1 wherein B is assumed to be zero.

5. The method of claim 1 wherein the I_{LOS}⁰ data are determined via conditional averaging using a sequence of two or more image frames containing I_{LOS}^{M} data for which a conditional average is calculated to identify and average intensity data for instances in which a moving plume has migrated away from a target location of interest.

6. The method of claim 1 wherein the I_{LOS}⁰ data are determined via conditional averaging using a sequence of two or more image frames containing I_{LOS}^{M} data for which the conditional average is constructed using tests of statistical significance to develop objective statistical criteria for identifying and averaging intensity data for instances in which a moving plume has migrated away from a target location of interest.

7. The method of claim 5 wherein the conditional averaging is used in combination with interpolation procedures.

8. The method of claim 6 wherein the conditional averaging is used in combination with interpolation procedures.

9. The method of claim 1 further comprising determining a velocity field of the atmospheric plume by using time-resolved reference transmissivity field (τ′) image data as a basis for cross-correlation measurements to achieve intrinsically weighted velocity measurement data along a line of sight of a velocity detection system.

10. The method of claim 9 wherein a logarithm of the time-resolved reference transmissivity field data is used to achieve a different intrinsic weighting of velocity measurement data along the line of sight of the velocity detection system.

11. The method of claim 9 wherein apparent transmissivity field data (τₑₓₚ) are used to achieve a different intrinsic weighting of velocity measurement data along the line of sight of the velocity detection system.

12. The method of claim 9 wherein a logarithm of apparent transmissivity field data is used to achieve a different intrinsic weighting of velocity measurement data along the line of sight of the velocity detection system.

13. The method of claim 9 wherein the detection system comprises two or more detectors which view the plume along different optical axes and further comprising combining data through cross-correlation to obtain a 3-D measurement of the weighted velocity field in the atmospheric plume.

14. The method of claim 1 further comprising relating the reference transmissivity to τ* and measured velocity field data to obtain mass emission rate (\dot{m}ₛₒₒₜ) data of targeted plume constituents in accordance with eq. (15)
$${\dot{m}}_{soot} = \frac{{ρ}_{soot} λ}{6 π ( 1 + {ρ}_{sa} ) {E ( m )}_{λ}} \int u ( y ) ( - ln [ {τ}^{*} ( y ) ] ) d y \qquad ( 15 )$$
where ρₛₒₒₜ is soot density, the coordinate axis y is perpendicular to both the optical axis (x) and the general flow direction of the plume, and u(y) is the component of the characteristic local velocity of the plume chord that is perpendicular to y and x.

15. The method of claim 2 further comprising relating the reference transmissivity to τ* and measured velocity field data to obtain mass emission rate (\dot{m}ₛₒₒₜ) data of targeted plume constituents in accordance with eq. (15)
$${\dot{m}}_{soot} = \frac{{ρ}_{soot} λ}{6 π ( 1 + {ρ}_{sa} ) {E ( m )}_{λ}} \int u ( y ) ( - ln [ {τ}^{*} ( y ) ] ) d y \qquad ( 15 )$$
where ρₛₒₒₜ is soot density, the coordinate axis y is perpendicular to both the optical axis (x) and the general flow direction of the plume, and u(y) is the component of the characteristic local velocity of the plume chord that is perpendicular to y and x.

16. The method of claim 14 wherein ρₛₐ is assumed to be zero.

17. The method of claim 9 wherein the detection system comprises two or more detectors and further comprising calculating velocity data using one or more of the two or more detectors and calculating transmissivity field data using one or more of the two or more detectors.

18. The method of claim 9 wherein the same optical detection system is used for transmissivity measurements and velocity measurements.

19. The method of claim 1 further comprising using measurements at two or more wavelength bands in the calculations and obtaining information about wavelength dependent scattering and absorption cross-sections of plume constituents.

20. The method of claim 2 further comprising using measurements at two or more wavelength bands in the calculations and obtaining information about wavelength dependent scattering and absorption cross-sections of plume constituents.

21. The method of claim 1, wherein the sky-light intensity distribution I_{sky}(α,Z) is obtained by one or more sky-light intensity distribution models.

22. The method of claim 1, wherein the sky-light intensity distribution I_{sky}(α,Z) is obtained by direct measurement.

23. The method of claim 1, wherein the optical detection system comprises a camera.

24. A non-transitory computer readable medium having computer readable instructions stored thereon for determining a spatially resolved reference transmissivity field (τ*) of an atmospheric plume, the instructions comprising instructions to:
obtain a spatially resolved measurement of plume and adjacent skylight intensity (I_{LOS}^{M}) using an optical detection system, an optical axis for the measurement being the optical detection system's optical axis, which transects the atmospheric plume and has an angle β relative to horizontal;
calculate an apparent transmissivity field (τₑₓₚ) as a ratio of spatially resolved I_{LOS}^{M} and I_{LOS}⁰ data where I_{LOS}⁰ is a spatially resolved reference background sky-intensity in a region of the sky behind the atmospheric plume;
calculate a relative contribution of in-scattered sky-light, B, in accordance with eq. 6b
$$\frac{B}{{I}_{LOS}^{0}} = \frac{1}{{I}_{LOS}^{0}} {\int }_{0}^{\frac{π}{2}} {\int }_{0}^{2 π} {I}_{sky} ( α , Z ) {{I}_{sky} ( α , Z )}_{h} \overline{{\frac{d {σ}_{agg}^{sc} ( θ ( α , Z ) )}{d Ω} }_{vv}} ( \frac{1 + {cos}^{2} θ ( α , Z )}{2} ) sin Z d α d Z \qquad ( 6 b )$$
where
I_{sky}(α,Z) is a radiance originating from a location in the sky specified by angles α and Z [W M⁻²ster⁻¹];
α is an azimuth angle between a first plane and a second plane, the first plane containing the sun and a measurement zenith axis and the second plane containing a position in the sky of interest and the measurement zenith axis, where the azimuth angle is defined to be positive in a clockwise direction relative to the first plane when looking down to the surface of the earth and the measurement zenith axis is defined as a vertical axis relative to the surface of the earth originating at a measurement location;
Z is a zenith angle between a line connecting a position in the sky of interest and the measurement zenith axis, the zenith angle being equal to zero when the position of the sky is directly above the measurement location;
θ(α,Z) is an angle between a line connecting the measurement location and the position in the sky of interest, defined by the angles α and Z, and a second line defined by the optical axis of the optical detection system, the angle θ being equal to zero when the position in the sky is intersected by the optical axis;
$$\overline{{\frac{d {σ}_{agg}^{sc} ( θ ( α , Z ) )}{d Ω} }_{vv}}$$
is the effective differential scattering cross-section of a soot aggregate with respect to solid angle, Ω, and is a function of the scattering angle, θ [m² ster⁻¹] and the subscript ‘vv’ indicates vertical polarization of both the incident and scattered light;
calculate of a ratio of sun intensity to sky intensity behind the atmospheric plume
$$( \frac{{E}_{sun}}{{I}_{LOS}^{0}} )$$
using measured data for intensity of the sun in the sky;
calculate a contribution of in-scattered sun-light, C, in accordance with eq. 6c
$$\frac{C}{{I}_{LOS }^{0}} = \frac{{E}_{sun}}{{I}_{LOS}^{0}} \overline{{\frac{d {σ}_{agg}^{sc} ( {θ}_{sun} )}{d Ω} }_{vv}} \frac{1 + {cos}^{2} {θ}_{sun}}{2} \qquad ( 6 c )$$
where θₛᵤₙ is an angle between a line connecting the measurement location and the sun and a second line defined by the optical axis of the optical detection system, the angle θₛᵤₙ being equal to zero when the optical detection system's optical axis intersects the sun;
calculate the reference transmissivity in accordance with eq. 16
$${τ}^{*} = ( {τ}_{ex p} - \frac{B + C}{{I}_{LOS}^{0} \overline{{σ}_{agg}^{ext }}} ) {( 1 - \frac{B + C}{{I}_{LOS}^{0} \overline{{σ}_{agg}^{ext}}} )}^{- 1} \qquad ( 16 )$$
where σ̅_̅{̅a̅g̅g̅}̅^̅{̅e̅x̅t̅}̅ is the measured or calculated extinction coefficient of the target constituents of the plume at a specified measurement wavelength band; and
output the reference transmissivity to an output device.

25. A method of determining a spatially resolved reference transmissivity field (r′) of an atmospheric plume, the method comprising:
obtaining a spatially resolved measurement of plume and adjacent skylight intensity (I_{LOS}^{M}) using an optical detection system, the optical axis for the measurement being the optical axis of the detection system, which transects the atmospheric plume and has an angle β relative to horizontal;
calculating an apparent transmissivity field (τₑₓₚ) as a ratio of spatially resolved I_{LOS}^{M} and I_{LOS}⁰ data where I_{LOS}⁰ is a spatially resolved reference background sky-intensity in a region of the sky behind the atmospheric plume;
calculating a relative contribution of in-scattered sky-light, B having regard to: a radiance originating from a location in the sky; an orientation of the sun with respect to a measurement location and the region of sky; and an effective differential scattering cross-section of a soot aggregate with respect to solid angle, Ω;
calculating of a ratio of sun intensity to sky intensity behind the atmospheric plume
$$( \frac{{E}_{sun}}{{I}_{LOS}^{0}} )$$
using measured data for intensity of the sun in the sky;
calculating a contribution of in-scattered sun-light, C, having regard to an angle between a line connecting the measurement location and the sun and a second line defined by the optical axis of the optical detection system;
calculating the reference transmissivity having regard to a measured or calculated extinction coefficient of the target constituents of the plume at a specified measurement wavelength band; and
outputting the reference transmissivity to an output device.
